(19) United States
(12) Patent Application Publication
(10) Pub. No.: US 2024/0233743 A1
(43) Pub. Date: Jul. 11, 2024

(54) INFORMATION PROCESSING APPARATUS, INFORMATION PROCESSING METHOD, INFORMATION PROCESSING PROGRAM, AND INFORMATION PROCESSING SYSTEM

(71) Applicant: SONY GROUP CORPORATION, TOKYO (JP)

(72) Inventors: RINA KOTANI, TOKYO (JP); SHIRO SUZUKI, TOKYO (JP)

(21) Appl. No.: 18/561,481

(22) PCT Filed: Feb. 25, 2022
(86) PCT No.: PCT/JP2022/007773

§ 371 Date: Nov. 16, 2023

(30) Foreign Application Priority Data
Jun. 8, 2021 (JP) 2021-095898

(51) Int. Cl. G10L 21/0272; G10L 17/02

(52) U.S. Cl. CPC G10L 21/0272; G10L 17/02

(57) ABSTRACT

An information processing apparatus (100) includes a signal acquiring unit (132), a signal identification unit (133), a signal processing unit (134), and a signal transmission unit (135). The signal acquiring unit (132) acquires, from a communication terminal, at least one of a first voice signal corresponding to a voice of a preceding speaker and a second voice signal corresponding to a voice of an intervening speaker. When the signal strengths of the first voice signal and the second voice signal exceed a predetermined threshold, the signal identification unit (133) specifies an overlapping section in which the first voice signal and the second voice signal overlap, and identifies either the first voice signal or the second voice signal as a phase inversion target in the overlapping section. The signal processing unit (134) performs phase inversion processing on one voice signal identified as the phase inversion target while the overlapping section continues. The signal transmission unit (135) adds one voice signal on which the phase inversion processing has been performed and the other voice signal on which the phase inversion processing has not been performed, and transmits the resulting signal to a communication terminal (10).

### FIELD

The present disclosure relates to an information processing apparatus, an information processing method, an information processing program, and an information processing system.

### BACKGROUND

Conventionally, there is a system for emphasizing a voice to be heard. For example, there has been proposed a hearing aid system that increases a perceptual sound pressure level by estimating a target sound from an external sound, separating the target sound from environmental noise, and causing the target sound to have an opposite phase between both ears.

Furthermore, in recent years, online communication (hereinafter, referred to as “online communication”) using a predetermined electronic device as a communication tool has been performed in various scenes regardless of business scenes.

### CITATION LIST

### Patent Literature

Patent Literature 1: JP 2015-39208 A

### SUMMARY

### Technical Problem

However, there is room for improvement in online communication in order to achieve smooth communication. For example, it is conceivable to use the above-described hearing aid system for online communication, but it is also conceivable that the hearing aid system is not suitable for online communication based on normal hearing.

Therefore, the present disclosure proposes an information processing apparatus, an information processing method, an information processing program, and an information processing system that can support so as to achieve smooth communication.

### Solution to Problem

To solve the above problem, an information processing apparatus that provides a service that requires an identity verification process according to an embodiment of the present disclosure includes: a signal acquiring unit that acquires at least one of a first voice signal corresponding to a voice of a preceding speaker and a second voice signal corresponding to a voice of an intervening speaker from a communication terminal; a signal identification unit that specifies an overlapping section in which the first voice signal and the second voice signal overlap with each other and identifies either the first voice signal or the second voice signal as a phase inversion target in the overlapping section when signal strengths of the first voice signal and the second voice signal exceed a predetermined threshold; a signal processing unit that performs phase inversion processing on one voice signal identified as the phase inversion target by the signal identification unit while the overlapping section continues; and a signal transmission unit that adds one voice signal on which the phase inversion processing has been performed and the other voice signal on which the phase inversion processing has not been performed, and transmits the added voice signal to the communication terminal.

### BRIEF DESCRIPTION OF DRAWINGS

FIG. 1 is a diagram illustrating an outline of information processing according to an embodiment of the present disclosure.

FIG. 2 is a diagram illustrating an outline of information processing according to the embodiment of the present disclosure.

FIG. 3 is a diagram illustrating a configuration example of an information processing system according to a first embodiment of the present disclosure.

FIG. 4 is a block diagram illustrating a device configuration example of each device included in the information processing system according to the first embodiment of the present disclosure.

FIG. 5 is a diagram illustrating a configuration example of an environment setting window according to the first embodiment of the present disclosure.

FIG. 6 is a diagram for describing a specific example of each unit of the information processing system according to the first embodiment of the present disclosure.

FIG. 7 is a diagram for describing a specific example of each unit of the information processing system according to the first embodiment of the present disclosure.

FIG. 8 is a diagram for describing a specific example of each unit of the information processing system according to the first embodiment of the present disclosure.

FIG. 9 is a diagram for describing a specific example of each unit of the information processing system according to the first embodiment of the present disclosure.

FIG. 10 is a flowchart illustrating an example of a processing procedure of an information processing apparatus according to the first embodiment of the present disclosure.

FIG. 11 is a diagram illustrating an outline of information processing according to a modification of the first embodiment of the present disclosure.

FIG. 12 is a diagram for describing a specific example of each unit of an information processing system according to a modification of the first embodiment of the present disclosure.

FIG. 13 is a diagram for describing a specific example of each unit of an information processing system according to a modification of the first embodiment of the present disclosure.

FIG. 14 is a flowchart illustrating an example of a processing procedure of an information processing apparatus according to a modification of the first embodiment of the present disclosure.

FIG. 15 is a block diagram illustrating a device configuration example of each device included in an information processing system according to a second embodiment of the present disclosure.

FIG. 16 is a diagram illustrating a configuration example of an environment setting window according to the second embodiment of the present disclosure.

FIG. 17 is a diagram for describing a specific example of each unit of the information processing system according to the second embodiment of the present disclosure.

FIG. 18 is a diagram for describing a specific example of each unit of the information processing system according to the second embodiment of the present disclosure.

FIG. 19 is a flowchart illustrating an example of a processing procedure of the information processing apparatus according to the second embodiment of the present disclosure.

FIG. 20 is a block diagram illustrating a hardware configuration example of a computer corresponding to an information processing apparatus according to each embodiment and modification of the present disclosure.

### DESCRIPTION OF EMBODIMENTS

Hereinafter, embodiments of the present disclosure will be described in detail with reference to the drawings. Note that, in the following embodiments, components having substantially the same functional configuration may be denoted by the same number or reference numeral, and redundant description may be omitted. In addition, in the present specification and the drawings, a plurality of components having substantially the same functional configuration may be distinguished and described by attaching different numbers or reference numerals after the same number or reference numeral.

Furthermore, the description of the present disclosure will be made according to the following item order.
1. Introduction
2. Embodiments
2-1. Overview of information processing
2-2. System configuration example
2-3. Device configuration example
2-3-1. Configuration example of communication terminal
2-3-2. Configuration example of information processing apparatus
2-3-3. Specific example of each unit of information processing system
2-4. Processing procedure example
3. Modification of first embodiment
3-1. Outline of information processing according to modification
3-2. Specific example of each unit of information processing system according to modification
3-3. Processing procedure example
4. Second Embodiment
4-1. Device configuration example
4-1-1. Configuration example of communication terminal
4-1-2. Configuration example of information processing apparatus
4-1-3. Specific example of each unit of information processing system
4-2. Processing procedure example
5. Others
6. Hardware configuration example
7. Conclusion

### 1. Introduction

In recent years, with the development of information processing technology and communication technology, there are more opportunities to use not only one-to-one communication but also online communication in which a plurality of people can easily communicate without actually facing each other. In particular, according to online communication in which communication is performed by voice or video using a predetermined system or application, it is possible to perform communication close to face-to-face conversation.

In such online communication, during an utterance of a user who is speaking in advance (hereinafter, the user is referred to as a “preceding speaker”), when an utterance of another user (hereinafter, referred to as an “intervening speaker”) unintentionally overlaps the utterance of the user, the voices of each other interfere with each other, and it is difficult for the listening side to hear the voice. Even in the case of voice intervention for a very short time, if a plurality of voices are input at the same time, the voice of the preceding speaker is interfered by the voice of the intervening speaker, and it becomes difficult to grasp the content. Such a situation hinders smooth communication and may lead to stress of each user during conversation. In addition, such a situation can occur not only in the interference by the voice of the intervening speaker but also in the environmental sound irrelevant to the content of the conversation.

For example, binaural masking level difference (BMLD), which is one of auditory psychological phenomena of people, is known as a technique applicable to signal processing for emphasizing a voice desired to hear. The outline of the binaural masking level difference will be described below.

For example, when there is an interference sound (also referred to as a “masker”) such as environmental noise, it is difficult to detect a target sound that one wants to hear, which is called masking. In addition, when the sound pressure level of the interference sound is constant, the sound pressure level of the target sound when the target sound can be barely detected by the interference sound is referred to as a masking threshold. Then, a difference between a masking threshold when the target sound having the same phase is heard between both ears in an environment where the interference sound having the same phase exists and a masking threshold when the target sound having the opposite phase is heard between both ears in an environment where the interference sound having the same phase exists is referred to as a binaural masking level difference. In addition to this, a binaural masking level difference also occurs when the phase of the target sound is kept the same and the phase of the interference sound is reversed. In particular, it has been reported that a binaural masking level difference psychologically equivalent to 15 dB (decibels) exists in the impression received by the listener when the listener hears the target sound having the opposite phase between both ears in an environment where the same white noise exists, as compared with the impression received when the listener hears the target sound having the same phase between both ears (See, for example, Literature 1.).

(Literature 1): “Hirsh, I. J. (1948). The influence of interaural phase on interaural summation and inhibition. Journal of the Acoustical Society of America, 20, 536-544.”

As described above, although there is an individual difference in the binaural masking level difference, by inverting the phase of the sound that enters one ear of the target sound, there is a case where the target sound is brought into the illusion sound that can be heard at different positions with respect to the interference sound. As a result, an effect of making the target sound easy to hear is expected.

For this reason, the present disclosure proposes an information processing apparatus, an information processing method, an information processing program, and an information processing system that can support smooth communication by applying the above-described binaural masking level difference in online communication.

### 2. Embodiments

### <2-1. Overview of Information Processing>

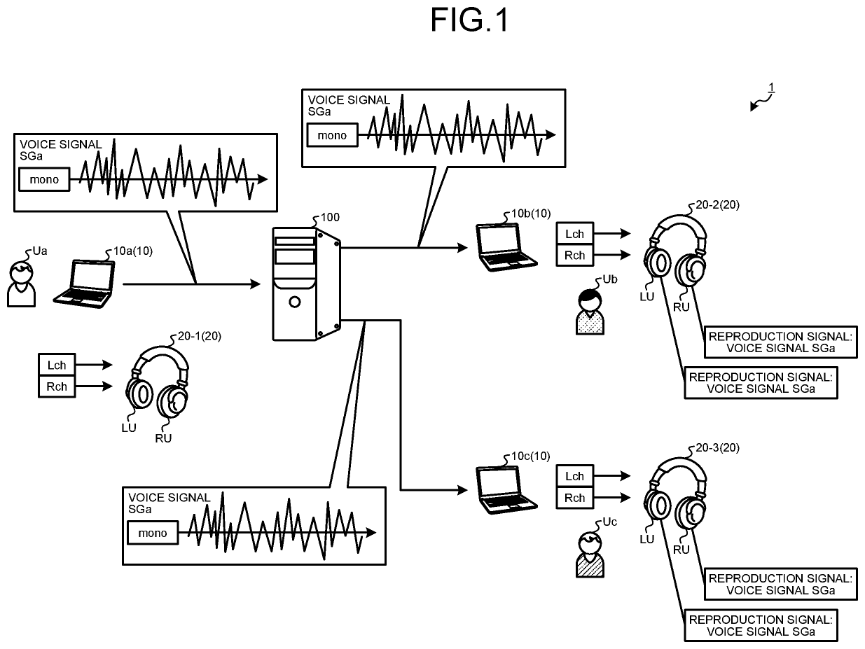

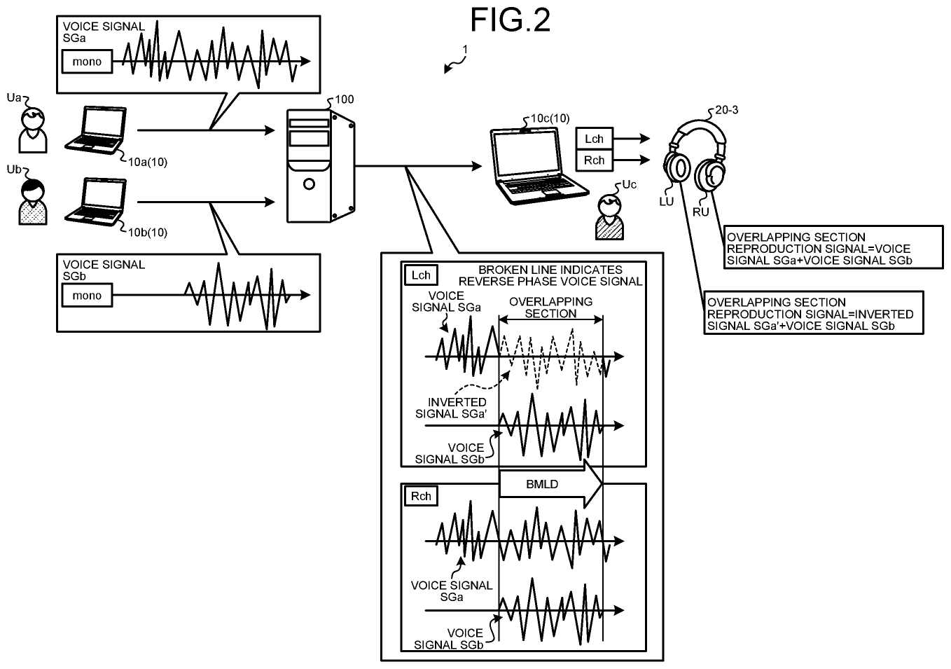

Hereinafter, an outline of information processing according to an embodiment of the present disclosure will be described. FIGS. 1 and 2 are diagrams illustrating an outline of information processing according to an embodiment of the present disclosure. Note that, in the following description, in a case where it is not necessary to particularly distinguish a communication terminal 10a, a communication terminal 10b, and a communication terminal 10c, they will be collectively referred to as “communication terminal 10”. Furthermore, in the following description, in a case where it is not necessary to particularly distinguish a user Ua, a user Ub, and a user Uc, they will be collectively referred to as “user U”. In addition, in the following description, in a case where it is not necessary to particularly distinguish headphones 20-1, headphones 20-2, and headphones 20-3, they will be collectively referred to as “headphones 20”.

As illustrated in FIGS. 1 and 2, an information processing system 1 according to an embodiment of the present disclosure provides a mechanism for implementing online communication performed among a plurality of users U. As illustrated in FIGS. 1 and 2, the information processing system 1 includes a plurality of communication terminals 10. Note that FIG. 1 or 2 illustrates an example in which the information processing system 1 includes the communication terminal 10a, the communication terminal 10b, and the communication terminal 10c as the communication terminal 10, but the information processing system 1 is not limited to the example illustrated in FIG. 1 or 2 and may include more communication terminals 10 than those illustrated in FIG. 1 or 2.

The communication terminal 10a is an information processing apparatus used by the user Ua as a communication tool for online communication. The communication terminal 10b is an information processing apparatus used by the user Ub as a communication tool for online communication. The communication terminal 10c is an information processing apparatus used by the user Uc as a communication tool for online communication.

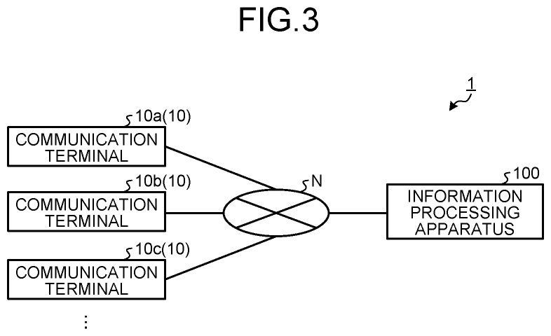

Further, each communication terminal 10 is connected to a network N (See, for example, FIG. 3). Each communication terminal 10 can communicate with an information processing apparatus 100 through the network N. The user U of each communication terminal 10 can communicate with another user U who is an event participant such as an online meeting through the platform provided by the information processing apparatus 100 by operating the online communication tool.

Furthermore, in the example illustrated in FIGS. 1 and 2, each communication terminal 10 is connected to the headphones 20 worn by the user U. Each communication terminal 10 includes an R channel (“Rch”) for audio output corresponding to the right ear unit RU included in the headphones 20 and an L channel (“Lch”) for audio output corresponding to the left ear unit LU included in the headphones 20. Each communication terminal 10 outputs the voice of another user U who is an event participant such as an online meeting from the headphones 20.

Furthermore, as illustrated in FIGS. 1 and 2, the information processing system 1 includes an information processing apparatus 100. The information processing apparatus 100 is an information processing apparatus that provides each user U with a platform for implementing online communication. The information processing apparatus 100 is connected to a network N (See, for example, FIG. 3). The information processing apparatus 100 can communicate with the communication terminal 10 through the network N.

The information processing apparatus 100 is implemented by a server device. Note that FIGS. 1 and 2 illustrate an example in which the information processing system 1 includes a single information processing apparatus 100, but the information processing system 1 is not limited to the example illustrated in FIGS. 1 and 2, and may include more information processing apparatuses 100 than those illustrated in FIGS. 1 and 2. Furthermore, the information processing apparatus 100 may be implemented by a cloud system in which a plurality of server devices and a plurality of storage devices connected to the network N operate in cooperation with each other.

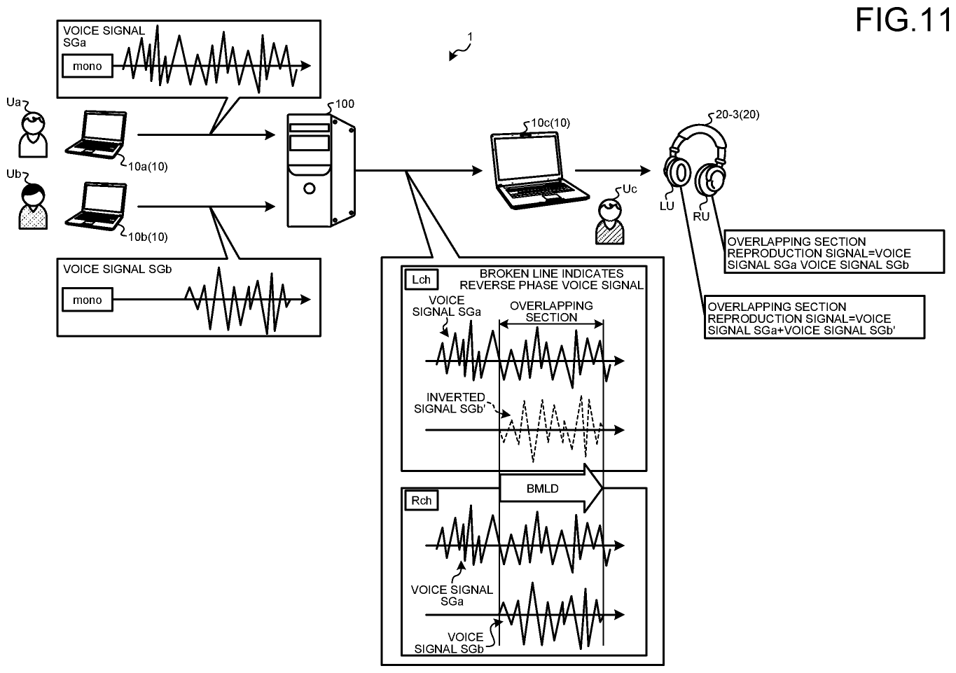

In the information processing system 1 having the above-described configuration, the information processing apparatus 100 comprehensively controls information processing related to online communication performed among a plurality of users U. Hereinafter, an example of information processing for emphasizing the voice of the user Ua who is a preceding speaker by applying the above-described binaural masking level difference (BMLD) in the online communication being executed among the user Ua, the user Ub, and the user Uc will be described. Note that a case where a voice signal transmitted from the communication terminal 10 to the information processing apparatus 100 is a monaural signal (for example, corresponding to “mono” illustrated in FIG. 1, FIG. 2, or FIG. 11) will be described below.

First, an example of information processing in a case where there is no voice intervention by another user U with respect to the voice of the user Ua who is a preceding speaker will be described with reference to FIG. 1.

As illustrated in FIG. 1, the information processing apparatus 100 marks the user Ua as a preceding speaker when the sound pressure level of the voice signal SGa acquired from the communication terminal 10a is equal to or higher than a predetermined threshold. The voice signal SGa is a phase inversion target in a case where voice intervention is performed. Then, in a case where there is no overlap of the intervention sounds during the marking period, the information processing apparatus 100 transmits the acquired voice signal SGa to each of the communication terminal 10b and the communication terminal 10c.

The communication terminal 10b outputs the voice signal SGa received from the information processing apparatus 100 from each of an R channel (“Rch”) corresponding to the right ear unit RU and an L channel (“Lch”) corresponding to the left ear unit LU of the headphones 20-2. The right ear unit RU and the left ear unit LU of the headphones 20-2 process the same voice signal SGa as a reproduction signal and perform audio output.

Similarly to the communication terminal 10b, the communication terminal 10c outputs the voice signal SGa received from the information processing apparatus 100 from each of the R channel (“Rch”) corresponding to the right ear unit RU and the L channel (“Lch”) corresponding to the left ear unit LU of the headphones 20-3. The right ear unit RU and the left ear unit LU of the headphones 20-3 process the same voice signal SGa as a reproduction signal and perform audio output.

Next, an example of information processing in a case where voice intervention by a voice of the user Ub who is an intervening speaker is performed on a voice of the user Ua who is a preceding speaker will be described with reference to FIG. 2. Note that the information processing described below is not limited to a case where voice intervention by the voice of the user Ub who is an intervening speaker is performed on the voice of the user Ua who is a preceding speaker, and can be similarly applied to a case where there is an intervention sound such as environmental noise collected by the communication terminal 10b used by the user Ub.

Further, FIG. 2 illustrates an example in which the phase inversion processing is performed on the voice signal output to the left ear side of the user U in order to give the effect of the binaural masking level difference to the voice signal of the preceding speaker. Furthermore, in the following description, the L channel (“Lch”) corresponding to the voice signal output to the left ear side of the user U on which the phase inversion processing is performed may be referred to as a “functional channel”, and the R channel (“Rch”) corresponding to the voice signal output to the right ear side of the user U on which the phase inversion processing is not performed may be referred to as a “non-functional channel”.

In the example illustrated in FIG. 2, the information processing apparatus 100 marks the user Ua as a preceding speaker when the sound pressure level of the voice signal SGa acquired from the communication terminal 10a is greater than or equal to a predetermined threshold.

Further, the information processing apparatus 100, when acquiring the voice signal SGb of the user Ub during the marking period, detects overlap between the voice signal SGa of the user Ua who is the preceding speaker and the voice signal SGb of the user Ub who is the intervening speaker. For example, the information processing apparatus 100 detects the overlap of the both signals under the condition that the voice signal SGb of the user Ub who is the intervening speaker is equal to or greater than a predetermined threshold during the marking period. Then, the information processing apparatus 100 specifies an overlapping section in which the voice signal SGa of the user Ua who is the preceding speaker and the voice signal SGb of the user Ub who is the intervening speaker overlap. For example, the information processing apparatus 100 specifies, as the overlapping section, a section from when the overlap of both signals is detected until the voice signal SGb of the user Ub who is the intervening speaker becomes less than a predetermined threshold during the marking period.

In addition, the information processing apparatus 100 replicates each of the voice signal SGa and the voice signal SGb. In addition, the information processing apparatus 100 executes phase inversion processing of the voice signal SGa that is a phase inversion target for the overlapping section of the voice signal SGa and the voice signal SGb. For example, the information processing apparatus 100 inverts the phase of the voice signal SGa in the overlapping section by 180 degrees. Furthermore, the information processing apparatus 100 generates the voice signal for the left ear by adding the inverted signal SGa′ obtained by the phase inversion processing and the voice signal SGb.

Furthermore, the information processing apparatus 100 generates the voice signal for the right ear by adding the voice signal SGa and the voice signal SGb in the specified overlapping section. Furthermore, the information processing apparatus 100 transmits the generated voice signal for the left ear to the communication terminal 10c through a path corresponding to the functional channel (“Lch”). Furthermore, the information processing apparatus 100 transmits the generated voice signal for the right ear to the communication terminal 10c through a path corresponding to the non-functional channel (“Rch”).

The communication terminal 10c outputs the voice signal for the right ear received from the information processing apparatus 100 to the headphones 20-3 through the R channel corresponding to the right ear unit RU of the headphones 20-3. Furthermore, the communication terminal 10c outputs the voice signal for the left ear received from the information processing apparatus 100 to the headphones 20-3 through the L channel corresponding to the left ear unit LU of the headphones 20-3.

The right ear unit RU of the headphones 20-3 processes the voice signal obtained by adding the voice signal SGa and the voice signal SGb as the reproduction signal in the overlapping section of the voice signal SGa and the voice signal SGb, and performs audio output. On the other hand, in the overlapping section of the voice signal SGa and the voice signal SGb, the left ear unit LU of the headphones 20-3 processes the voice signal obtained by adding the inverted signal SGa′ obtained by performing the phase inversion processing on the voice signal SGa and the voice signal SGb as the reproduction signal, and performs audio output. As described above, in the information processing system 1, in a case where voice interference between the user Ua and the user Ub occurs in an online meeting or the like, the information processing apparatus 100 performs signal processing of giving an effect of a binaural masking level difference to the voice signal of the user Ua. As a result, a voice signal emphasized so that the voice of the user Ua who is a preceding speaker can be easily heard is provided to the user Uc.

### <2-2. System Configuration Example>

Hereinafter, a configuration of an information processing system 1 according to a first embodiment of the present disclosure will be described with reference to FIG. 3. FIG. 3 is a diagram illustrating a configuration example of an information processing system according to a first embodiment of the present disclosure.

As illustrated in FIG. 3, the information processing system 1 according to the first embodiment includes a plurality of communication terminals 10 and an information processing apparatus 100. Each communication terminal 10 and the information processing apparatus 100 are connected to a network N. Each communication terminal 10 can communicate with another communication terminal 10 and the information processing apparatus 100 through the network N. The information processing apparatus 100 can communicate with the communication terminal 10 through the network N.

The network N may include a public line network such as the Internet, a telephone line network, or a satellite communication network, various local area networks (LANs) including Ethernet (registered trademark), a wide area network (WAN), or the like. The network N may include a dedicated line network such as an Internet protocol-virtual private network (IP-VPN). Furthermore, the network 50 may include a wireless communication network such as Wi-Fi (registered trademark) or Bluetooth (registered trademark).

The communication terminal 10 is an information processing apparatus used by the user U (See, for example, FIGS. 1 and 2.) as a communication tool for online communication. The user U (See, for example, FIGS. 1 and 2.) of each communication terminal 10 can communicate with another user U who is an event participant of an online meeting or the like through the platform provided by the information processing apparatus 100 by operating the online communication tool.

The communication terminal 10 has various functions for implementing online communication. For example, the communication terminal 10 includes a communication device including a modem, an antenna, or the like for communicating with another communication terminal 10 or the information processing apparatus 100 via the network N, and a display device including a liquid crystal display, a drive circuit, or the like for displaying an image including a still image or a moving image. Furthermore, the communication terminal 10 includes an audio output device such as a speaker that outputs the voice or the like of another user U in the online communication, and an audio input device such as a microphone that inputs the voice or the like of the user U in the online communication. Furthermore, the communication terminal 10 may include a photographing device such as a digital camera that photographs the user U and the surroundings of the user U.

The communication terminal 10 is implemented by, for example, a desktop personal computer (PC), a notebook PC, a tablet terminal, a smartphone, a personal digital assistant (PDA), a wearable device such as a head mounted display (HMD), or the like.

The information processing apparatus 100 is an information processing apparatus that provides each user U with a platform for implementing online communication. The information processing apparatus 100 is implemented by a server device. Furthermore, the information processing apparatus 100 may be implemented by a single server device, or may be implemented by a cloud system in which a plurality of server devices and a plurality of storage devices connected to the network N operate in cooperation.

### <2-3. Device Configuration Example>

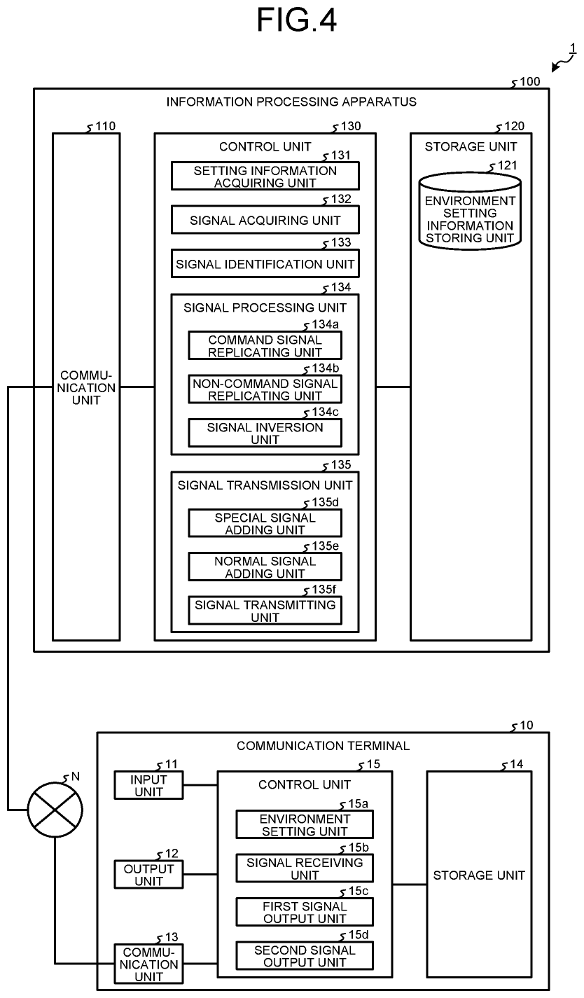

Hereinafter, a device configuration of each device included in the information processing system 1 according to the first embodiment of the present disclosure will be described with reference to FIG. 4. FIG. 4 is a block diagram illustrating a device configuration example of each device included in the information processing system according to the first embodiment of the present disclosure.

### (2-3-1. Configuration Example of Communication Terminal)

As illustrated in FIG. 4, the communication terminal 10 included in the information processing system 1 includes an input unit 11, an output unit 12, a communication unit 13, a storage unit 14, and a control unit 15. Note that FIG. 4 illustrates an example of a functional configuration of the communication terminal 10 according to the first embodiment, and is not limited to the example illustrated in FIG. 4, and other configurations may be used.

The input unit 11 receives various operations. The input unit 11 is implemented by an input device such as a mouse, a keyboard, or a touch panel. Furthermore, the input unit 11 includes an audio input device such as a microphone that inputs a voice or the like of the user U in the online communication. Furthermore, the input unit 11 may include a photographing device such as a digital camera that photographs the user U or the surroundings of the user U.

For example, the input unit 11 receives an input of initial setting information regarding online communication. Furthermore, the input unit 11 receives a voice input of the user U who has uttered during execution of the online communication.

The output unit 12 outputs various types of information. The output unit 12 is implemented by an output device such as a display or a speaker. Furthermore, the output unit 12 may be integrally configured including headphones, an earphone, and the like connected via a predetermined connection unit.

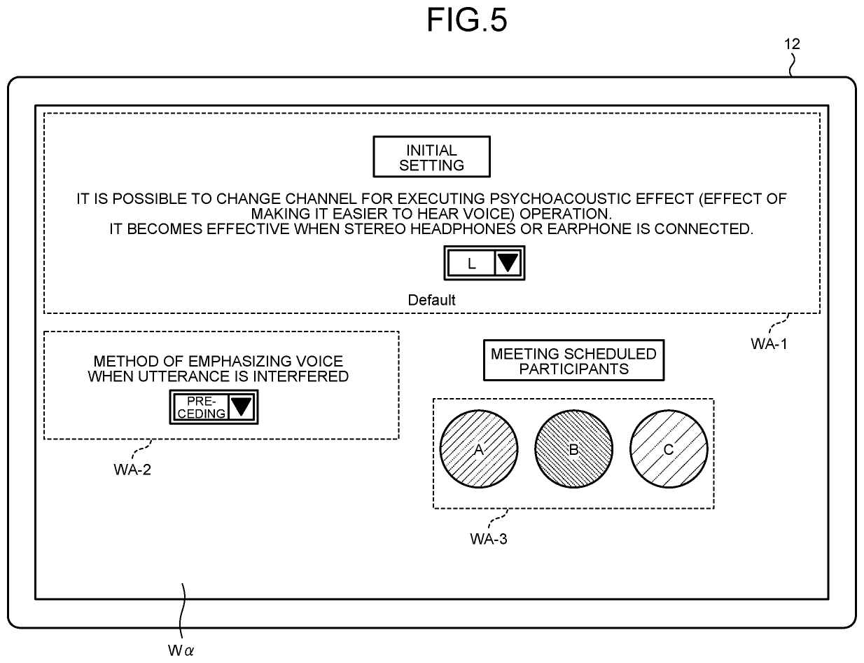

For example, the output unit 12 displays an environment setting window (See, for example, FIG. 5.) for initial setting regarding online communication.

Furthermore, the output unit 12 outputs a voice or the like corresponding to the voice signal of the other party user received by the communication unit 13 during execution of the online communication.

The communication unit 13 transmits and receives various types of information. The communication unit 13 is implemented by a communication module or the like for transmitting and receiving data to and from another device such as another communication terminal 10 or the information processing apparatus 100 in a wired or wireless manner. The communication unit 13 communicates with other devices by a method such as wired local area network (LAN), wireless LAN, Wi-Fi (registered trademark), infrared communication, Bluetooth (registered trademark), near field communication, or non-contact communication.

For example, the communication unit 13 receives a voice signal of the communication partner from the information processing apparatus 100 during execution of the online communication. Furthermore, during execution of the online communication, the communication unit 13 transmits the voice signal of the user U input by the input unit 11 to the information processing apparatus 100.

The storage unit 14 is implemented by, for example, a semiconductor memory element such as a random access memory (RAM) or a flash memory, or a storage device such as a hard disk or an optical disk. The storage unit 14 can store, for example, programs, data, and the like for implementing various processing functions executed by the control unit 15. The programs stored in the storage unit 14 include an operating system (OS) and various application programs. For example, the storage unit 14 can store an application program for performing online communication such as an online meeting through a platform provided from the information processing apparatus 100. Furthermore, the storage unit 14 can store information indicating whether each of a first signal output unit 15c and a second signal output unit 15d described later corresponds to a functional channel or a non-functional channel.

The control unit 15 is implemented by a control circuit including a processor and a memory. The various processing executed by the control unit 15 are implemented, for example, by executing a command described in a program read from an internal memory by a processor using the internal memory as a work area. The program read from the internal memory by the processor includes an operating system (OS) and an application program. Furthermore, the control unit 15 may be implemented by, for example, an integrated circuit such as an application specific integrated circuit (ASIC), a field-programmable gate array (FPGA), or a system-on-a-chip (SoC).

Furthermore, the main storage device and the auxiliary storage device functioning as the internal memory described above are implemented by, for example, a semiconductor memory element such as a random access memory (RAM) or a flash memory, or a storage device such as a hard disk or an optical disk.

As illustrated in FIG. 4, the control unit 15 includes environment setting unit 15a, a signal receiving unit 15b, a first signal output unit 15c, and a second signal output unit 15d.

The environment setting unit 15a executes various settings related to the online communication when executing the online communication. FIG. 5 is a diagram illustrating a configuration example of an environment setting window according to the first embodiment of the present disclosure. Note that FIG. 5 illustrates an example of the environment setting window according to the first embodiment, and is not limited to the example illustrated in FIG. 5, and may have a configuration different from the example illustrated in FIG. 5.

For example, the environment setting unit 15a, when recognizing the connection of the headphones 20, executes output setting such as channel assignment with respect to the headphones 20, and after completion of the setting, displays an environment setting window Wα illustrated in FIG. 5 on the output unit 12. Then, the environment setting unit 15a receives various setting operations regarding the online communication from the user through the environment setting window Wα. Specifically, the environment setting unit 15a receives, from the user, the setting of a target sound as a target of the phase inversion operation that brings about the binaural masking level difference.

As described below, the setting of the target sound includes selection of a channel corresponding to the target sound and selection of an emphasis method. The channel corresponds to an R channel (“Rch”) for audio output corresponding to the right ear unit RU included in the headphones 20 or an L channel (“Lch”) for audio output corresponding to the left ear unit LU included in the headphones 20. In addition, when an utterance is interfered by an intervention sound in online communication (when overlap of an intervention sound is detected), the emphasis method corresponds to a method of emphasizing a preceding voice corresponding to a preceding speaker or a method of emphasizing the intervention sound intervening in the preceding voice.

As illustrated in FIG. 5, in a display region WA-1 included in the environment setting window Wa, a drop-down list (also referred to as “pull-down”) for receiving the selection of the channel corresponding to the target sound from the user is provided. In the example illustrated in FIG. 5, “L” is displayed on the drop-down list as a predetermined setting (default). When “L” is selected, an L channel (“Lch”) is set as a functional channel, and the phase inversion processing is performed on a voice signal corresponding to the L channel. Note that, although not illustrated in FIG. 5, “R” indicating the R channel (“Rch”) is included in the drop-down list as the selection item of the channel for which the phase inversion processing is executed. The setting of the functional channel can be arbitrarily selected and switched by the user U according to his/her ear state or preference.

Furthermore, in a display region WA-2 included in the environment setting window Wa illustrated in FIG. 5, a drop-down list for receiving the selection of the emphasis method from the user is provided. In the example illustrated in FIG. 5, “preceding” is displayed on the drop-down list. In a case where “preceding” is selected, processing for emphasizing the voice signal corresponding to the preceding voice is performed. Note that, although not illustrated in FIG. 5, the drop-down list includes, as the selection items of the emphasis method, “following” to be selected in a case where the voice signal corresponding to the intervention sound is emphasized.

In addition, in a display region WA-3 included in the environment setting window Wa illustrated in FIG. 5, information of meeting scheduled participants is displayed. In FIG. 5, conceptual information is illustrated as information indicating meeting scheduled participants, but more specific information such as names and face images may be displayed. Note that, in the first embodiment, the environment setting window Wet illustrated in FIG. 5 does not have to display information on meeting scheduled participants.

The environment setting unit 15a sends, to the communication unit 13, environment setting information regarding the environment setting received from the user through the environment setting window Wa illustrated in FIG. 5. As a result, the environment setting unit 15a can transmit the environment setting information to the information processing apparatus 100 via the communication unit 13.

Returning to FIG. 4, the signal receiving unit 15b receives the voice signal of the online communication transmitted from the information processing apparatus 100 through the communication unit 13. In a case where the first signal output unit 15c corresponds to the non-functional channel (“Rch”), the signal receiving unit 15b sends the voice signal for the right ear received from the information processing apparatus 100 to the first signal output unit 15c. Furthermore, in a case where the second signal output unit 15d corresponds to the functional channel (“Lch”), the signal receiving unit 15b sends the voice signal for the left ear received from the information processing apparatus 100 to the second signal output unit 15d.

The first signal output unit 15c outputs the voice signal acquired from the signal receiving unit 15b to the headphones 20 through a path corresponding to the non-functional channel (“Rch”). For example, the first signal output unit 15c, when receiving the voice signal for the right ear from the signal receiving unit 15b, outputs the voice signal for the right ear to the headphones 20. Note that in a case where the communication terminal 10 and the headphones 20 are wirelessly connected, the first signal output unit 15c can transmit the voice signal for the right ear to the headphones 20 through the communication unit 13.

The second signal output unit 15d outputs the voice signal acquired from the signal receiving unit 15b to the headphones 20 through a path corresponding to the functional channel (“Lch”). For example, the second signal output unit 15d, when acquiring the voice signal for the left ear from the signal receiving unit 15b, outputs the voice signal for the left ear to the headphones 20. Note that in a case where the communication terminal 10 and the headphones 20 are wirelessly connected, the second signal output unit 15d can transmit the voice signal for the left ear to the headphones 20 through the communication unit 13.

### (2-3-2. Configuration Example of Information Processing Apparatus)

Furthermore, as illustrated in FIG. 4, the information processing apparatus 100 included in the information processing system 1 includes a communication unit 110, a storage unit 120, and a control unit 130.

The communication unit 110 transmits and receives various types of information. The communication unit 110 is implemented by a communication module or the like for transmitting and receiving data to and from another device such as the communication terminal 10 in a wired or wireless manner. The communication unit 110 communicates with other devices by a method such as wired local area network (LAN), wireless LAN, Wi-Fi (registered trademark), infrared communication, Bluetooth (registered trademark), near field communication, or non-contact communication.

For example, the communication unit 110 receives the environment setting information transmitted from the communication terminal 10. The communication unit 110 sends the received environment setting information to the control unit 130. Furthermore, for example, the communication unit 110 receives a voice signal transmitted from the communication terminal 10. The communication unit 110 sends the received voice signal to the control unit 130. Furthermore, for example, the communication unit 110 transmits a voice signal generated by the control unit 130 described later to the communication terminal 10.

The storage unit 120 is implemented by, for example, a semiconductor memory element such as a random access memory (RAM) or a flash memory, or a storage device such as a hard disk or an optical disk. The storage unit 14 can store, for example, programs, data, and the like for implementing various processing functions executed by the control unit 15. The programs stored in the storage unit 14 include an operating system (OS) and various application programs.

As illustrated in FIG. 4, the storage unit 120 includes an environment setting information storing unit 121. The environment setting information storing unit 121 stores the environment setting information received from the communication terminal 10 in association with the user U of the communication terminal 10. The environment setting information includes, for each user, information on a functional channel selected by the user, information on an emphasis method, and the like.

The control unit 130 is implemented by a control circuit including a processor and a memory. The various processing executed by the control unit 130 are implemented, for example, by executing a command described in a program read from an internal memory by a processor using the internal memory as a work area. The program read from the internal memory by the processor includes an operating system (OS) and an application program. Furthermore, the control unit 130 may be implemented by, for example, an integrated circuit such as an application specific integrated circuit (ASIC), a field-programmable gate array (FPGA), or a system-on-a-chip (SoC).

As illustrated in FIG. 4, the control unit 130 includes a setting information acquiring unit 131, a signal acquiring unit 132, a signal identification unit 133, a signal processing unit 134, and a signal transmission unit 135.

The setting information acquiring unit 131 acquires the environment setting information received by the communication unit 110 from the communication terminal 10. Then, the setting information acquiring unit 131 stores the acquired environment setting information in the environment setting information storing unit 121.

The signal acquiring unit 132 acquires the voice signal transmitted from the communication terminal 10 through the communication unit 110. For example, at least one of a first voice signal corresponding to the voice of the preceding speaker and a second voice signal corresponding to the voice of the intervening speaker is acquired from the communication terminal 10. The signal acquiring unit 132 sends the acquired voice signal to the signal identification unit 133.

When the signal strengths of the first voice signal and the second voice signal exceed a predetermined threshold, the signal identification unit 133 detects an overlapping section in which the first voice signal and the second voice signal are overlappingly input, and identifies the first voice signal or the second voice signal as a phase inversion target in the overlapping section.

For example, the signal identification unit 133 refers to the environment setting information stored in the environment setting information storing unit 121, and identifies the voice signal as the phase inversion target on the basis of the corresponding emphasis method. In addition, the signal identification unit 133 marks the user U associated with the identified voice signal. As a result, during the execution of the online communication, the signal identification unit 133 identifies the voice signal of the user U who can be the target of the phase inversion operation from among the plurality of users U who are event participants of the online meeting or the like.

For example, in a case where “preceding” that emphasizes the voice of the preceding speaker is set as the corresponding emphasis method, the signal identification unit 133 marks the user U of the voice immediately after voice input sufficient for conversation is started from silence (A signal equal to or less than a certain minute threshold, or a signal equal to or less than a sound pressure that can be recognized as a voice) after the start of the online communication. The signal identification unit 133 continues the marking of the voice of the target user U until the voice of the target user U becomes silent (A signal equal to or less than a certain minute threshold, or a signal equal to or less than a sound pressure that can be recognized as a sound).

Furthermore, the signal identification unit 133 executes overlap detection for detecting a voice (intervention sound) equal to or greater than a threshold input from at least one or more other participants during the utterance of the marked user U (during the marking period). That is, when “preceding” that emphasizes the voice of the preceding speaker is set, the signal identification unit 133 specifies an overlapping section in which the voice signal of the preceding speaker and the voice signal (intervention sound) of the intervening speaker overlap.

Furthermore, in a case where the overlap of the intervention sound is detected while the marking of the voice signal of the target user U is being continued, the signal identification unit 133 sends the voice signal acquired from the marked user U as a command voice signal and the voice signals acquired from the other users U as non-command voice signals to the signal processing unit 134 in the subsequent stage in two paths. Note that the signal identification unit 133 classifies the voice signal into two paths in a case where the overlap of voices is detected, but sends the received voice signal to a non-command signal replicating unit 134b described later in a case where overlapping of voices is not detected.

The signal processing unit 134 processes the voice signal acquired from the signal identification unit 133. As illustrated in FIG. 4, the signal processing unit 134 includes a command signal replicating unit 134a, a non-command signal replicating unit 134b, and a signal inversion unit 134c.

The command signal replicating unit 134a replicates the voice signal for the functional channel and the voice signal for the non-functional channel using the command voice signal acquired from the signal identification unit 133. The command signal replicating unit 134a sends the replicated voice signal to the signal inversion unit 134c. In addition, the command signal replicating unit 134a sends the replicated voice signal to the signal transmission unit 135.

The non-command signal replicating unit 134b replicates the voice signal for the functional channel and the voice signal for the non-functional channel using the non-command voice signal acquired from the signal identification unit 133. The non-command signal replicating unit 134b sends the replicated voice signal to the signal transmission unit 135.

The signal inversion unit 134c performs phase inversion processing on one voice signal identified as a phase inversion target by the signal identification unit 133 while the overlapping section continues. Specifically, the signal inversion unit 134c executes phase inversion processing of inverting the phase of the original waveform of the command voice signal acquired from the command signal replicating unit 134a by 180 degrees. The signal inversion unit 134c sends the inverted signal obtained by performing the phase inversion processing on the command voice signal to the signal transmission unit 135.

The signal transmission unit 135 performs transmission processing of adding one voice signal on which the phase inversion processing has been performed and the other voice signal on which the phase inversion processing has not been performed, and transmitting the added signal to the communication terminal 10. As illustrated in FIG. 4, the signal transmission unit 135 includes a special signal adding unit 135d, a normal signal adding unit 135e, and a signal transmitting unit 135f.

The special signal adding unit 135d adds the non-command voice signal acquired from the non-command signal replicating unit 134b and the inverted signal acquired from the signal inversion unit 134c. The special signal adding unit 135d sends the added voice signal to the signal transmitting unit 135f.

The normal signal adding unit 135e adds the command voice signal acquired from the command signal replicating unit 134a and the non-command voice signal acquired from the non-command signal replicating unit 134b. The normal signal adding unit 135e sends the added voice signal to the signal transmitting unit 135f.

The signal transmitting unit 135f executes transmission processing for transmitting the voice signal acquired from the special signal adding unit 135d and the voice signal acquired from the normal signal adding unit 135e to each communication terminal 10. Specifically, the signal transmitting unit 135f refers to the environment setting information stored in the environment setting information storing unit 121, and specifies a functional channel and a non-functional channel corresponding to each user. The signal transmitting unit 135f transmits the voice signal acquired from the special signal adding unit 135d to the communication terminal 10 through the path of the functional channel, and transmits the voice signal acquired from the normal signal adding unit 135e to the communication terminal 10 through the path of the non-functional channel.

### (2-3-3. Specific Example of Each Unit of Information Processing System)

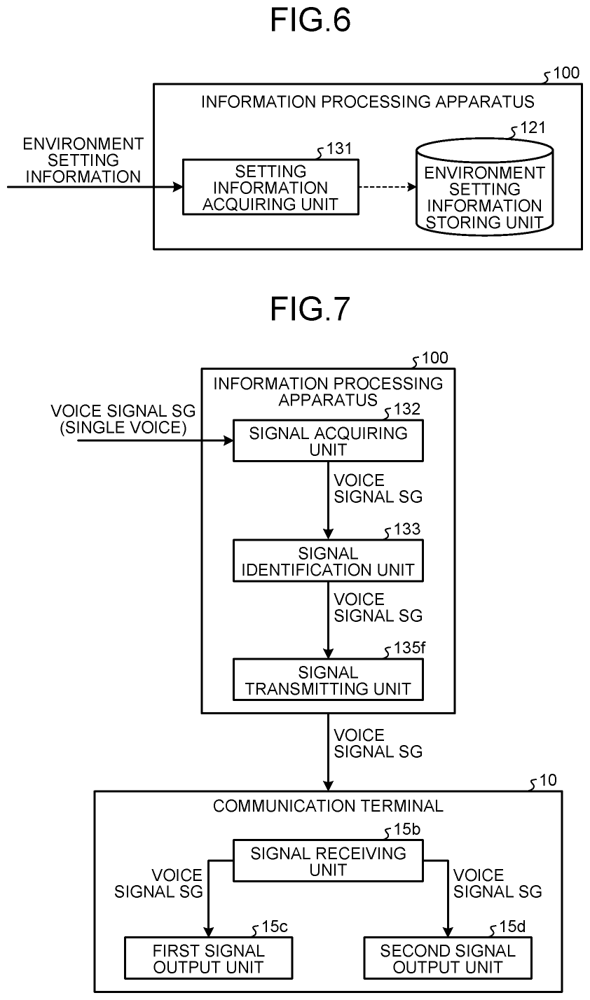

Hereinafter, a specific example of each unit of the information processing system 1 will be described with reference to the drawings. FIGS. 6 to 9 are diagrams for describing specific examples of each unit of the information processing system according to the first embodiment of the present disclosure. Note that an operation of each unit assuming a case where a voice of a preceding speaker is emphasized will be described below.

As illustrated in FIG. 6, the setting information acquiring unit 131 of the information processing apparatus 100 acquires the environment setting information transmitted from the communication terminal 10. Then, the setting information acquiring unit 131 stores the acquired environment setting information in the environment setting information storing unit 121.

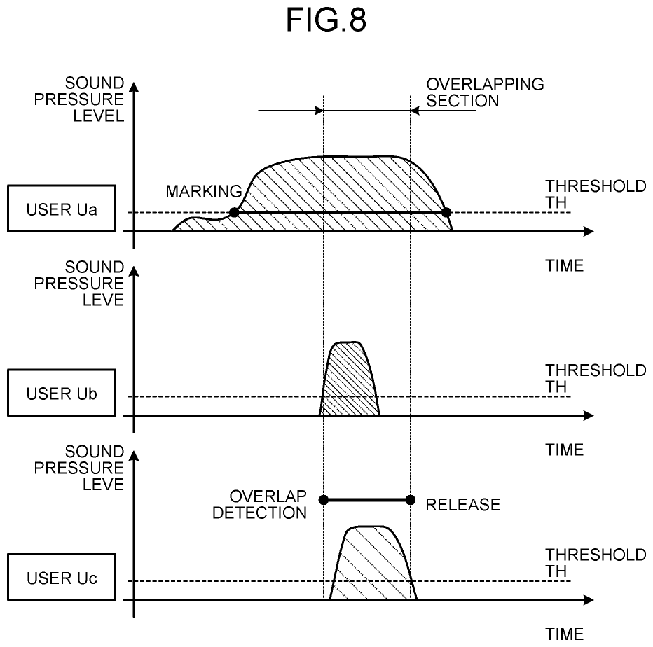

Furthermore, as illustrated in FIG. 7, the signal acquiring unit 132 of the information processing apparatus 100 sends the acquired voice signal SG to the signal identification unit 133. As illustrated in FIG. 8, after starting the online communication, for example, the signal identification unit 133 determines whether the sound pressure level of the voice signal SG of the user Ua acquired by the signal acquiring unit 132 is equal to or higher than a threshold TH. The signal identification unit 133, when determining that the sound pressure level of the voice signal SG is equal to or higher than the threshold TH, marks the user Ua as a preceding speaker.

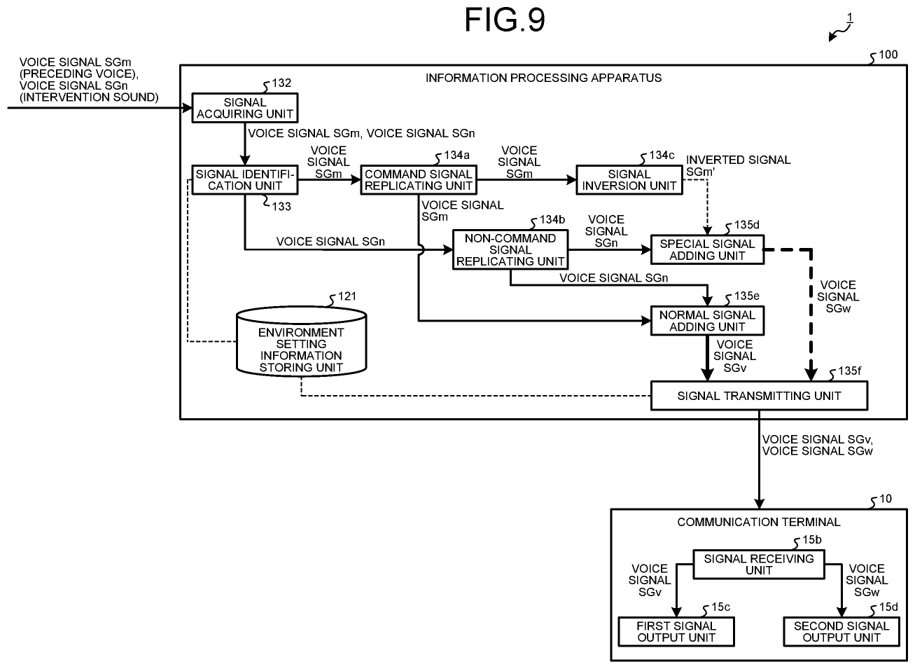

Subsequently, the signal identification unit 133 executes overlap detection for detecting overlap of the intervention sound (voice signal of the intervening speaker) input from the user Ub and the user Uc who are other participants in the online communication and equal to or higher than the threshold TH during the utterance of the marked user Ua. When the overlap of the intervention sound is not detected, the signal identification unit 133 sends the voice signal SG to the signal transmitting unit 135f until the transmission of the voice signal SG of the preceding speaker is completed. On the other hand, when the overlap of the intervention sound is detected, the signal identification unit 133 executes an operation illustrated in FIG. 9 to be described later.

The signal receiving unit 15b of the communication terminal 10 sends the voice signal SG received from the information processing apparatus 100 to each of the first signal output unit 15c and the second signal output unit 15d. Each of the first signal output unit 15c and the second signal output unit 15d outputs the voice signal SG acquired from the signal receiving unit 15b.

Further, as illustrated in FIG. 9, the signal acquiring unit 132 acquires a voice signal SGm corresponding to the preceding speaker and a voice signal SGn corresponding to the intervening speaker. The signal acquiring unit 132 sends the acquired voice signal SGm and the voice signal SGn to the signal identification unit 133.

Similarly to the example illustrated in FIG. 8 described above, after the online communication is started, for example, the signal identification unit 133 determines whether the sound pressure level of the voice signal SGm of the user Ua acquired by the signal acquiring unit 132 is equal to or higher than the threshold TH. The signal identification unit 133, when determining that the sound pressure level of the voice signal SGm is equal to or higher than the threshold TH, marks the user Ua as a preceding speaker.

Subsequently, in a case where the voice signal SGn input from the user Ub or the user Uc who is another participant in the online communication is equal to or greater than the threshold TH during the utterance of the marked user Ua, the signal identification unit 133 detects the voice signal as the overlap of the intervention sound (see FIG. 8). For example, in the example illustrated in FIG. 8, after marking the user Ua, the overlap of the voice signal of the user Ua and the voice signal of the user Ub is detected, and thereafter, overlap of the voice signal of the user Ua and the voice signal of the user Uc is detected. Then, when the overlap of the intervention sound is detected, the signal identification unit 133 sends the voice signal SGm of the preceding speaker as a command voice signal to the command signal replicating unit 134a and sends the voice signal SGn of the intervening speaker as a non-command signal to the non-command signal replicating unit 134b while the overlapping section continues. Note that, in a case of a single voice (in a case where there is no overlap of utterances), the signal identification unit 133 sends the voice signal SGm to the non-command signal replicating unit 134b, and does not send the voice signal to the command signal replicating unit 134a. In addition, the content of the voice signal to be sent from the signal identification unit 133 to the non-command signal replicating unit 134b is different between a case where there is overlap of the intervention sound with respect to the preceding voice and a case of the single voice where there is no overlap of the intervention sound. Table 1 below shows details of the voice signals sent from the signal identification unit 133 to the command signal replicating unit 134a or the non-command signal replicating unit 134b in an organized manner.

TABLE 1

| | | SGm (PRECEDING |
|---|---|---|
| | | VOICE), |
| | SGm | SGn |
| | (SINGLE | (INTERVENTION |
| INPUT VOICE | VOICE) | SOUND) |
| OVERLAP DETECTION | X (NO OVERLAP) | ◯ (OVERLAP) |
| TRANSMISSION TO | No | SGm |
| COMMAND SIGNAL | | |
| REPLICATING UNIT | | |
| TRANSMISSION TO | SGm | SGn |
| NON-COMMAND SIGNAL | | |
| REPLICATING UNIT | | |

In addition, the command signal replicating unit 134a replicates the voice signal SGm acquired from the signal identification unit 133 as a command voice signal. Then, the command signal replicating unit 134a sends the replicated voice signal SGm to the signal inversion unit 134c and the normal signal adding unit 135e.

In addition, the non-command signal replicating unit 134b replicates the voice signal SGn acquired from the signal identification unit 133 as a non-command voice signal. Then, the non-command signal replicating unit 134b sends the replicated voice signal SGn to the special signal adding unit 135d and the normal signal adding unit 135e.

The signal inversion unit 134c performs phase inversion processing on the voice signal SGm acquired as the command signal from the command signal replicating unit 134a. As a result, the voice signal for which the operation for emphasizing the voice signal SGm of the user Ua has been performed is generated in the voice overlapping section. The signal inversion unit 134c sends an inverted signal SGm′ on which the phase inversion processing has been performed to the special signal adding unit 135d.

The special signal adding unit 135d adds the voice signal SGn acquired from the non-command signal replicating unit 134b and the inverted signal SGm′ acquired from the signal inversion unit 134c. The special signal adding unit 135d sends the added voice signal SGw to the signal transmitting unit 135f. Note that, in a case of a single voice (in a case where there is no overlap of utterances), the special signal adding unit 135d sends the voice signal SGm acquired from the non-command signal replicating unit 134b to the signal transmitting unit 135f as the voice signal SGw.

The normal signal adding unit 135e adds the voice signal SGm acquired from the command signal replicating unit 134a and the voice signal SGn acquired from the non-command signal replicating unit 134b. The normal signal adding unit 135e sends the added voice signal SGv to the signal transmitting unit 135f. Note that, in a case of a single voice (in a case where there is no overlap of utterances), the normal signal adding unit 135e sends the voice signal SGm acquired from the non-command signal replicating unit 134b to the signal transmitting unit 135f as the voice signal SGv.

The signal transmitting unit 135f transmits the voice signal SGw acquired from the special signal adding unit 135d and the voice signal SGv acquired from the normal signal adding unit 135e to the communication terminal 10 through the path of the corresponding channel.

For example, the signal transmitting unit 135f assigns a path corresponding to an R channel (Rch) that is a non-functional channel to the voice signal SGv, and assigns a path corresponding to an L channel (Lch) that is a functional channel to the voice signal SGw. The signal transmitting unit 135f transmits the voice signal SGv and the voice signal SGw to the communication terminal 10c through each path. As a result, in the communication terminal 10c, the voice of the user Ua who is the preceding speaker is output in a highlighted state.

### <2-4. Processing Procedure Example>

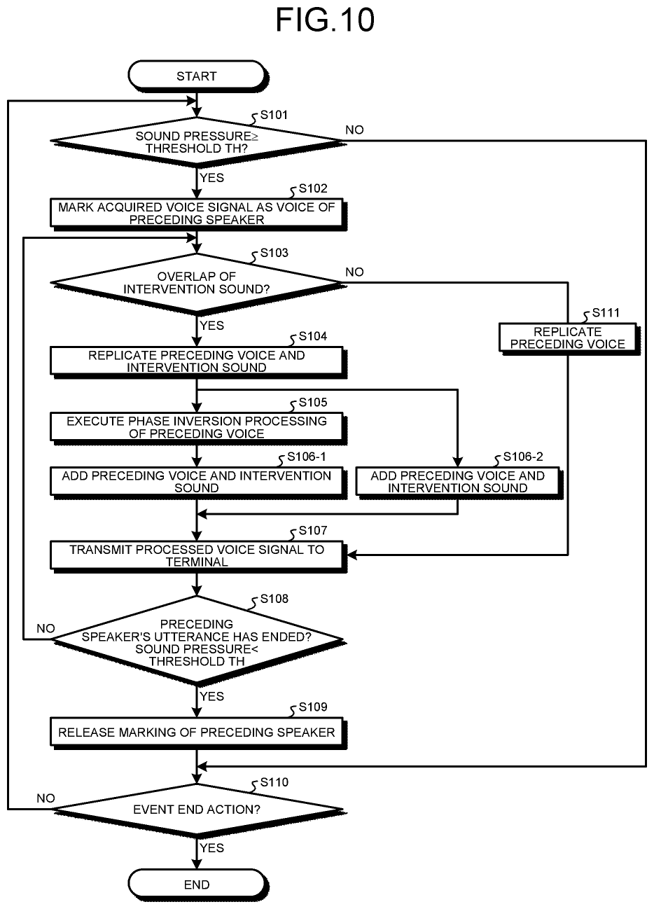

Hereinafter, a processing procedure by the information processing apparatus 100 according to the first embodiment of the present disclosure will be described with reference to FIG. 10. FIG. 10 is a flowchart illustrating an example of a processing procedure of the information processing apparatus according to the first embodiment of the present disclosure. The processing procedure illustrated in FIG. 10 is executed by the control unit 130 included in the information processing apparatus 100.

As illustrated in FIG. 10, the signal identification unit 133 determines whether the sound pressure level of the voice signal acquired from the signal acquiring unit 132 is equal to or greater than a predetermined threshold (Step S101).

In addition, the signal identification unit 133, when determining that the sound pressure level of the voice signal is equal to or greater than the predetermined threshold (Step S101; Yes), marks the acquired voice signal as the voice of the preceding speaker (Hereinafter, the voice is appropriately referred to as a “preceding voice”.) (Step S102).

Furthermore, the signal identification unit 133 determines whether or not there is overlap of intervention sound (For example, the voice of the intervening speaker) input from another participant in the online communication during the utterance of the marked preceding speaker (Step S103).

When the signal identification unit 133 determines that the intervention sound overlaps (Step S103; Yes), the signal processing unit 134 replicates the preceding voice and the intervention sound (Step S104). Then, the signal processing unit 134 executes phase inversion processing of the voice signal corresponding to the preceding voice (Step S105). Specifically, the command signal replicating unit 134a replicates the voice signal corresponding to the preceding voice acquired from the signal identification unit 133, and sends the replicated voice signal to the signal transmission unit 135. The non-command signal replicating unit 134b replicates a voice signal corresponding to the intervention sound acquired from the signal identification unit 133, and sends the voice signal to the signal transmission unit 135. In addition, the signal inversion unit 134c sends, to the signal transmission unit 135, an inverted signal obtained by performing phase inversion processing on the voice signal corresponding to the preceding voice.

In addition, the signal transmission unit 135 adds the preceding voice acquired from the signal processing unit 134 and the intervention sound (Step S106-1, S106-2). Specifically, in the processing procedure of Step S106-1, the special signal adding unit 135d adds the inverted signal corresponding to the preceding voice acquired from the signal inversion unit 134c and the voice signal corresponding to the intervention sound acquired from the non-command signal replicating unit 134b. The special signal adding unit 135d sends the added voice signal to the signal transmitting unit 135f. In addition, in the processing procedure of Step S106-2, the normal signal adding unit 135e adds the voice signal corresponding to the preceding voice acquired from the command signal replicating unit 134a and the voice signal corresponding to the intervention sound acquired from the non-command signal replicating unit 134b. The normal signal adding unit 135e sends the added voice signal to the signal transmitting unit 135f.

In addition, the signal transmission unit 135 transmits the processed voice signal to the communication terminal 10 (Step S107).

Further, the signal identification unit 133 determines whether or not the preceding speaker's utterance has ended (Step S108). Specifically, for example, when the sound pressure level of the voice signal corresponding to the preceding voice is less than a predetermined threshold, the signal identification unit 133 determines that the preceding speaker's utterance has ended.

If the signal identification unit 133 determines that the preceding speaker's utterance has not ended (Step S108; No), the processing returns to the processing procedure of Step S103 described above.

On the other hand, when the signal identification unit 133 determines that the preceding speaker's utterance has ended (Step S108; Yes), the marking on the preceding speaker is released (Step S109).

Furthermore, the control unit 130 determines whether or not an event end action has been received from the communication terminal 10 (Step S110). For example, the control unit 130 can end the processing procedure illustrated in FIG. 10 on the basis of a command from the communication terminal 10. Specifically, the control unit 130, when receiving the end command of the online communication from the communication terminal 10 during the execution of the processing procedure illustrated in FIG. 10, can determine that an event end action has been received. For example, the end command can be configured to be transmittable from the communication terminal 10 to the information processing apparatus 100 by using an operation of the user U on an “end” button displayed on the screen of the communication terminal 10 as a trigger during execution of the online communication.

In a case where the control unit 130 determines that the event end action has not been received (Step S110; No), the processing returns to the processing procedure of Step S101 described above.

On the other hand, the control unit 130, when determining that the event end action has been received (Step S110; Yes), ends the processing procedure illustrated in FIG. 10.

When the signal identification unit 133 determines that the intervention sound does not overlap in the processing procedure of Step S103 described above (Step S103; No), that is, in a case where the acquired voice signal is a single voice, the signal processing unit 134 replicates only the preceding voice (Step S111), and proceeds to the processing procedure of Step S107 described above.

In the processing procedure of Step S101 described above, when the signal identification unit 133 determines that the sound pressure level of the voice signal is less than the predetermined threshold (Step S101; No), the processing proceeds to the processing procedure of Step S110 described above.

### 3. Modification of First Embodiment

### <3-1. Outline of Information Processing According to Modification>

In the first embodiment described above, an example of the information processing for emphasizing the voice of the preceding speaker has been described. Hereinafter, as a modification of the first embodiment, an example of information processing for emphasizing the voice of the intervening speaker as the intervention sound will be described. FIG. 11 is a diagram illustrating an outline of information processing according to a modification of the first embodiment of the present disclosure. Furthermore, an example of information processing on the assumption that voice intervention by the user Ub has been performed on the voice of the user Ua who is a preceding speaker will be described below, similarly to FIG. 2 described above.

As illustrated in FIG. 11, the information processing apparatus 100, when acquiring the voice signal SGa transmitted from the communication terminal 10a, marks the acquired voice signal SGa as the voice signal of the preceding speaker.

Further, the information processing apparatus 100, when acquiring the voice signal SGb of the user Ub during the marking period, detects overlap between the voice signal SGa of the user Ua who is the preceding speaker and the voice signal SGb of the user Ub who is the intervening speaker. Then, the information processing apparatus 100 specifies an overlapping section in which the voice signal SGa and the voice signal SGb overlap.

In addition, the information processing apparatus 100 replicates each of the voice signal SGa and the voice signal SGb. In addition, the information processing apparatus 100 executes phase inversion processing of the voice signal SGb of the intervening speaker who is the phase inversion target for the overlapping section of the voice signal SGa and the voice signal SGb. For example, the information processing apparatus 100 inverts the phase of the voice signal SGb in the overlapping section by 180 degrees. Furthermore, the information processing apparatus 100 generates the voice signal for the left ear by adding the voice signal SGa and the inverted signal SGb′ obtained by the phase inversion processing.

Furthermore, the information processing apparatus 100 generates the voice signal for the right ear by adding the voice signal SGa and the voice signal SGb in the specified overlapping section. Furthermore, the information processing apparatus 100 transmits the generated voice signal for the left ear to the communication terminal 10c as a voice signal for a functional channel (Lch). Furthermore, the information processing apparatus 100 transmits the generated voice signal for the right ear to the communication terminal 10c as a voice signal for a non-functional channel (Rch).

The communication terminal 10c outputs the voice signal for the right ear received from the information processing apparatus 100 from the channel Rch corresponding to the right ear unit RU of the headphones 20-3. Furthermore, the communication terminal 10c outputs the voice signal for the left ear received from the information processing apparatus 100 from the channel Lch corresponding to the left ear unit LU. The right ear unit RU of the headphones 20-3 processes the voice signal obtained by adding the voice signal SGa and the voice signal SGb as the reproduction signal in the overlapping section of the voice signal SGa and the voice signal SGb, and performs audio output. On the other hand, in the overlapping section of the voice signal SGa and the voice signal SGb, the left ear unit LU of the headphones 20-3 processes the voice signal obtained by adding the voice signal SGa and the inverted signal SGb′ obtained by performing the phase inversion processing on the voice signal SGb as the reproduction signal and performs audio output. This makes it possible to provide, to the user Uc, a voice signal obtained by giving an effect of a binaural masking level difference to a voice signal of the user Ub who is an intervening speaker.

### <3-2. Specific Example of Each Unit of Information Processing System According to Modification>

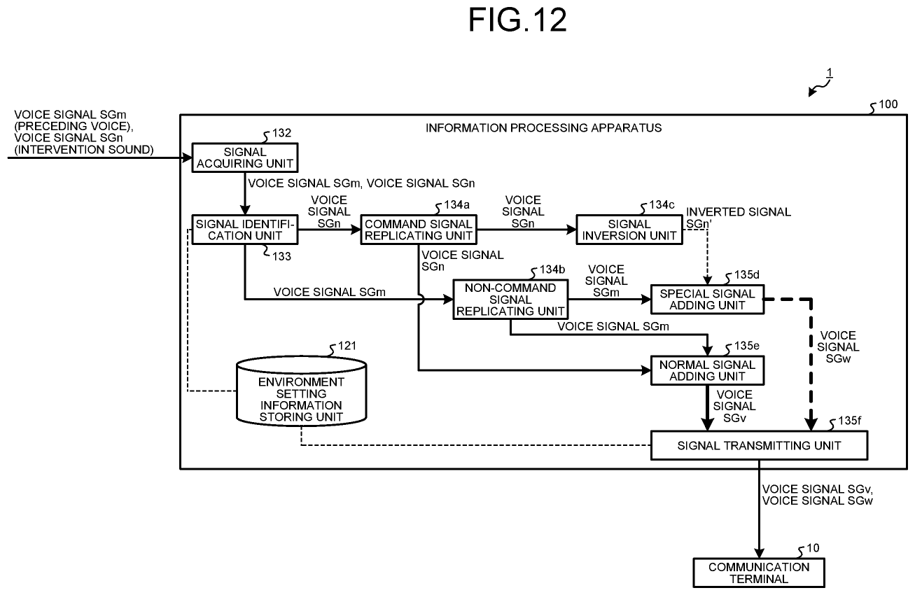

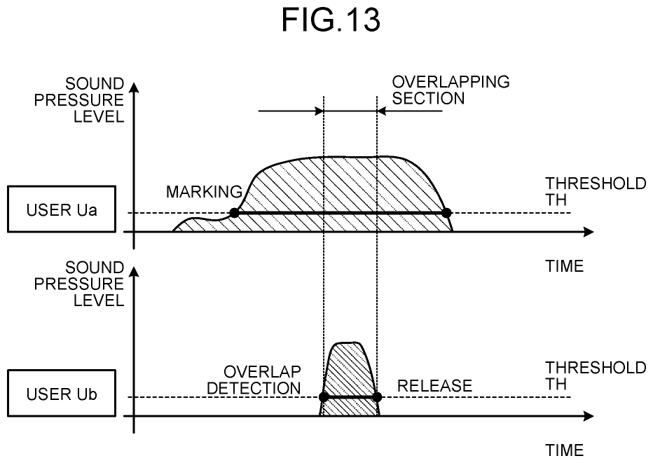

Hereinafter, a specific example of each unit of an information processing system according to a modification of the first embodiment will be described. FIGS. 12 and 13 are diagrams for describing a specific example of each unit of the information processing system according to the modification of the first embodiment of the present disclosure.

As illustrated in FIG. 12, the signal acquiring unit 132 acquires a voice signal SGm corresponding to the preceding speaker and a voice signal SGn corresponding to the intervening speaker. The signal acquiring unit 132 sends the acquired voice signal SGm and the voice signal SGn to the signal identification unit 133.

After starting the online communication, for example, the signal identification unit 133 determines whether or not the sound pressure level of the voice signal SGm of the user Ua acquired by the signal acquiring unit 132 is equal to or higher than the threshold TH. The signal identification unit 133, when determining that the sound pressure level of the voice signal SGm is equal to or higher than the threshold TH, marks the user Ua as a preceding speaker.

Subsequently, in a case where the voice signal SGn input from the user Ub or the user Uc who is another participant in the online communication is equal to or higher than the threshold TH during the utterance of the marked user Ua, the signal identification unit 133 detects the voice signal as the overlap of the intervention sound. For example, in the example illustrated in FIG. 13, after marking the user Ua, overlapping of the voice signal of the user Ua and the voice signal of the user Ub is detected. Then, when overlap of the intervention sound is detected, the signal identification unit 133 sends the voice signal SGm of the preceding speaker as a non-command voice signal to the non-command signal replicating unit 134b and sends the voice signal SGn of the intervening speaker as a command signal to the command signal replicating unit 134a while the overlapping section continues. Note that, in a case of a single voice (in a case where there is no overlap of utterances), the signal identification unit 133 sends the voice signal SGm to the non-command signal replicating unit 134b, and does not send the voice signal to the command signal replicating unit 134a. In addition, the content of the voice signal to be sent from the signal identification unit 133 to the non-command signal replicating unit 134b is different between a case where there is overlap of the intervention sound with respect to the preceding voice and a case of the single voice where there is no overlap of the intervention sound. Table 2 below shows details of the voice signals to be sent from the signal identification unit 133 to the command signal replicating unit 134a or the non-command signal replicating unit 134b in an organized manner.

TABLE 2

| | | SGm (PRECEDING |
|---|---|---|
| | | VOICE), |
| | | SGn |
| | SGm (SINGLE | (INTERVENTION |
| INPUT VOICE | VOICE) | SOUND) |
| OVERLAP DETECTION | X (NO OVERLAP) | ◯ (OVERLAP) |
| TRANSMISSION TO | No | SGn |
| COMMAND SIGNAL | | |
| REPLICATING UNIT | | |
| TRANSMISSION TO | SGm | SGm |
| NON-COMMAND SIGNAL | | |
| REPLICATING UNIT | | |

In addition, the command signal replicating unit 134a replicates the voice signal SGn acquired from the signal identification unit 133 as a command voice signal. Then, the command signal replicating unit 134a sends the replicated voice signal SGn to the signal inversion unit 134c and the normal signal adding unit 135e.

In addition, the non-command signal replicating unit 134b replicates the voice signal SGm acquired from the signal identification unit 133 as a non-command voice signal. Then, the non-command signal replicating unit 134b sends the replicated voice signal SGm to the special signal adding unit 135d and the normal signal adding unit 135e.

The signal inversion unit 134c performs phase inversion processing of the voice signal SGn acquired as the command signal from the command signal replicating unit 134a. As a result, the voice signal for which the operation for emphasizing the voice signal SGn of the user Ub has been performed is generated in the voice overlapping section. The signal inversion unit 134c sends the inverted signal SGn′ on which the phase inversion processing has been performed to the special signal adding unit 135d.

The special signal adding unit 135d adds the voice signal SGm acquired from the non-command signal replicating unit 134b and the inverted signal SGn′ acquired from the signal inversion unit 134c. The special signal adding unit 135d sends the added voice signal SGw to the signal transmitting unit 135f. Note that, in a case of a single voice (in a case where there is no overlap of utterances), the special signal adding unit 135d directly sends the voice signal SGm acquired from the non-command signal replicating unit 134b to the signal transmitting unit 135f as the voice signal SGw.

The normal signal adding unit 135e adds the voice signal SGn acquired from the command signal replicating unit 134a and the voice signal SGm acquired from the non-command signal replicating unit 134b. The normal signal adding unit 135e sends the added voice signal SGv to the signal transmitting unit 135f. Note that, in a case of a single voice (in a case where there is no overlap of utterances), the normal signal adding unit 135e directly sends the voice signal SGm acquired from the non-command signal replicating unit 134b to the signal transmitting unit 135f as the voice signal SGv.

The signal transmitting unit 135f transmits the voice signal SGw acquired from the special signal adding unit 135d and the voice signal SGv acquired from the normal signal adding unit 135e to the communication terminal 10 through the path of the corresponding channel.

For example, the signal transmitting unit 135f assigns a path corresponding to an R channel (Rch) that is a non-functional channel to the voice signal SGv, and assigns a path corresponding to an L channel (Lch) that is a functional channel to the voice signal SGw. The signal transmitting unit 135f transmits the voice signal SGv and the voice signal SGw to the communication terminal 10c through each path. As a result, in the communication terminal 10c, the voice of the user Ub who is the intervening speaker is output in a highlighted state.

### <3-3. Processing Procedure Example>

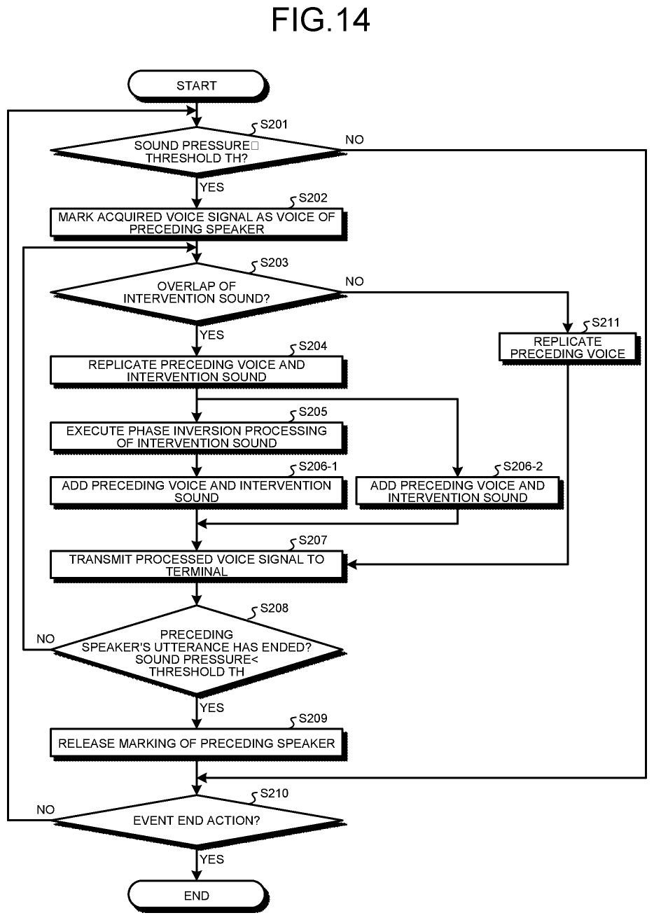

Hereinafter, a processing procedure by the information processing apparatus 100 according to a modification of the first embodiment of the present disclosure will be described with reference to FIG. 14. FIG. 14 is a flowchart illustrating an example of a processing procedure of an information processing apparatus according to a modification of the first embodiment of the present disclosure. The processing procedure illustrated in FIG. 14 is executed by the control unit 130 included in the information processing apparatus 100.

As illustrated in FIG. 14, the signal identification unit 133 determines whether the sound pressure level of the voice signal acquired from the signal acquiring unit 132 is equal to or greater than a predetermined threshold (Step S201).

In addition, the signal identification unit 133, when determining that the sound pressure level of the voice signal is equal to or greater than the predetermined threshold (Step S201; Yes), marks the acquired voice signal as the voice of the preceding speaker (Hereinafter, the voice is appropriately referred to as a “preceding voice”.) (Step S202).

Furthermore, the signal identification unit 133 determines whether or not there is overlap of intervention sound (including, for example, the voice of the intervening speaker.) input from another participant in the online communication during the utterance of the marked preceding speaker (Step S203).

When the signal identification unit 133 determines that the intervention sound overlaps (Step S203; Yes), the signal processing unit 134 replicates the preceding voice and the intervention sound (Step S204). Then, the signal processing unit 134 executes phase inversion processing of the voice signal corresponding to the intervention sound (Step S205). Specifically, the command signal replicating unit 134a replicates a voice signal corresponding to the intervention sound acquired from the signal identification unit 133, and sends the voice signal to the signal transmission unit 135. The non-command signal replicating unit 134b replicates a voice signal corresponding to the preceding voice acquired from the signal identification unit 133, and sends the voice signal to the signal transmission unit 135. Further, the signal inversion unit 134c sends, to the signal transmission unit 135, an inverted signal obtained by performing phase inversion processing on the voice signal corresponding to the intervention sound.

In addition, the signal transmission unit 135 adds the preceding voice acquired from the signal processing unit 134 and the intervention sound (Step S206-1, S206-2). Specifically, in the processing procedure of Step S206-1, the special signal adding unit 135d adds the voice signal corresponding to the preceding voice acquired from the non-command signal replicating unit 134b and the inverted signal corresponding to the intervention sound acquired from the signal inversion unit 134c. The special signal adding unit 135d sends the added voice signal to the signal transmitting unit 135f. In addition, in the processing procedure of Step S206-2, the normal signal adding unit 135e adds the voice signal corresponding to the intervention sound acquired from the command signal replicating unit 134a and the voice signal corresponding to the preceding voice acquired from the non-command signal replicating unit 134b. The normal signal adding unit 135e sends the added voice signal to the signal transmitting unit 135f.

In addition, the signal transmission unit 135 transmits the processed voice signal to the communication terminal 10 (Step S207).

Further, the signal identification unit 133 determines whether or not the preceding speaker's utterance has ended (Step S208). Specifically, for example, when the sound pressure level of the voice signal corresponding to the preceding voice is less than a predetermined threshold, the signal identification unit 133 determines that the preceding speaker's utterance has ended.

If the signal identification unit 133 determines that the preceding speaker's utterance has not ended (Step S208; No), the processing returns to the processing procedure of Step S203 described above.

On the other hand, the signal identification unit 133, when determining that the preceding speaker's utterance has ended (Step S208; Yes), releases the marking on the preceding speaker (Step S209).

Furthermore, the control unit 130 determines whether or not an event end action has been received from the communication terminal 10 (Step S210). For example, the control unit 130 can end the processing procedure illustrated in FIG. 14 on the basis of a command from the communication terminal 10. Specifically, the control unit 130, when receiving the end command of the online communication from the communication terminal 10 during the execution of the processing procedure illustrated in FIG. 14, can determine that the event end action has been received. For example, the end command can be configured to be transmittable from the communication terminal 10 to the information processing apparatus 100 by using an operation of the user on an “end” button displayed on the screen of the communication terminal 10 as a trigger during execution of the online communication.

The control unit 130, when determining that the event end action has not been received (Step S210; No), returns to the processing procedure of Step S201 described above.

On the other hand, the control unit 130, when determining that the event end action has been received (Step S210; Yes), ends the processing procedure illustrated in FIG. 14.

When the signal identification unit 133 determines that the intervention sound does not overlap in the processing procedure of Step S203 described above (Step S203; No), that is, when the acquired voice signal is a single voice, the signal processing unit 134 replicates only the preceding voice (Step S211), and proceeds to the processing procedure of Step S207 described above.

In the processing procedure of Step S201 described above, the signal identification unit 133, when determining that the sound pressure level of the voice signal is less than the predetermined threshold (Step S201; No), proceeds to the processing procedure of Step S210 described above.

### 4. Second Embodiment

### <4-1. Device Configuration Example>

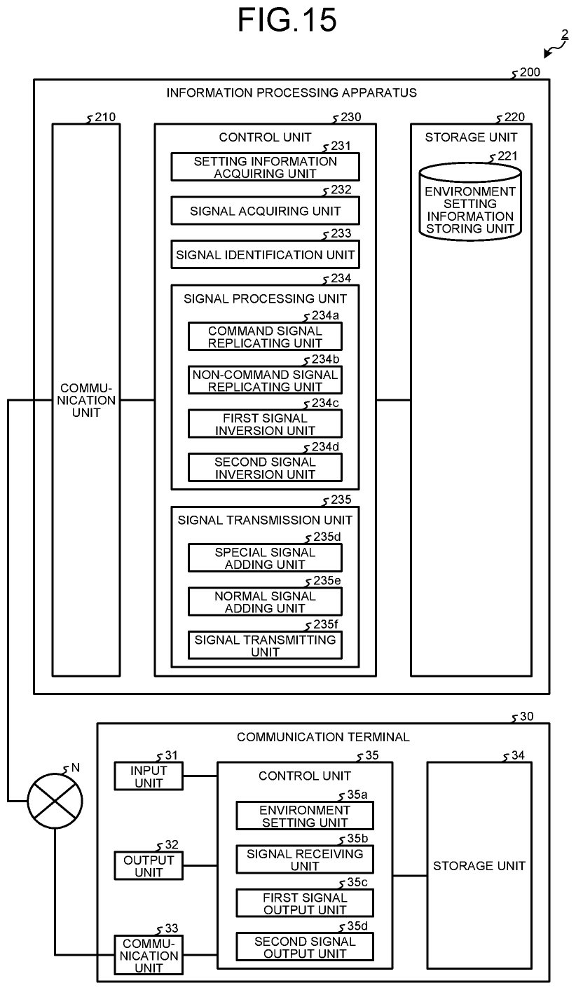

Hereinafter, a device configuration of each device included in an information processing system 2 according to a second embodiment of the present disclosure will be described with reference to FIG. 15. FIG. 15 is a block diagram illustrating a device configuration example of each device included in the information processing system according to the second embodiment of the present disclosure.

### (4-1-1. Configuration Example of Communication Terminal)

As illustrated in FIG. 15, a communication terminal 30 according to the second embodiment of the present disclosure has a configuration basically similar to the configuration (see FIG. 4) of the communication terminal 10 according to the first embodiment. Specifically, an input unit 31, an output unit 32, a communication unit 33, a storage unit 34, and a control unit 35 included in the communication terminal 30 according to the second embodiment respectively correspond to the input unit 11, the output unit 12, the communication unit 13, the storage unit 14, and the control unit 15 included in the communication terminal 10 according to the first embodiment.

Furthermore, an environment setting unit 35a, a signal receiving unit 35b, a first signal output unit 35c, and a second signal output unit 35d included in the control unit 35 of the communication terminal 30 according to the second embodiment respectively correspond to the environment setting unit 15a, the signal receiving unit 15b, the first signal output unit 15c, and the second signal output unit 15d included in the communication terminal 10 according to the first embodiment.

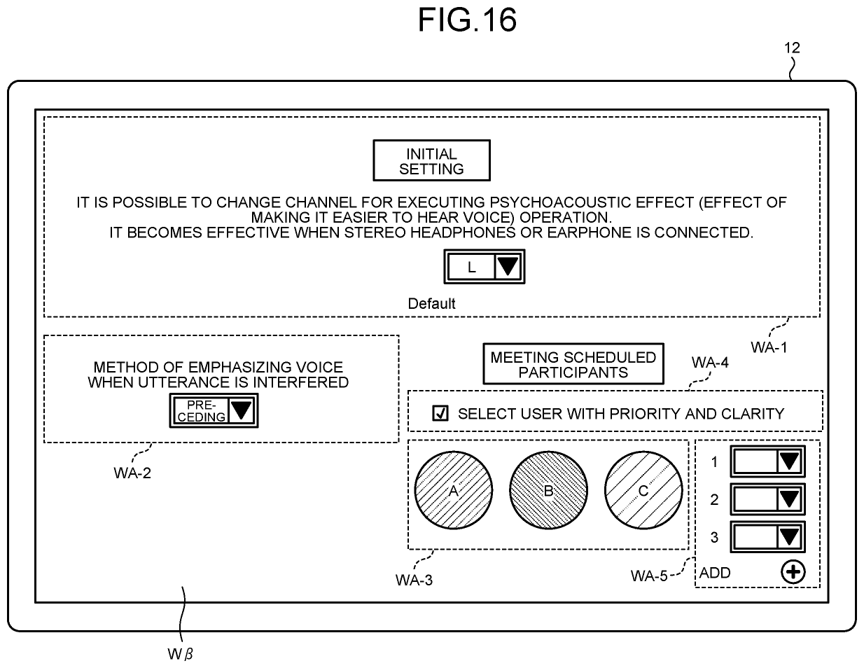

In the communication terminal 30 according to the second embodiment, a part of environment setting information set by the environment setting unit 35a is different from the environment setting information set by the environment setting unit 15a of the communication terminal 10 according to the first embodiment. FIG. 16 is a diagram illustrating a configuration example of an environment setting window according to the second embodiment of the present disclosure. Note that FIG. 16 illustrates an example of the environment setting window according to the second embodiment, and is not limited to the example illustrated in FIG. 16, and may have a configuration different from the example illustrated in FIG. 16.

The environment setting unit 35a receives, from a user U, a setting of priority information indicating a voice to be emphasized in a voice overlapping section for each of a plurality of users who can be preceding speakers or intervening speakers. The environment setting unit 35a sends, to the communication unit 33, environment setting information regarding the environment setting received from the user through an environment setting window Wβ illustrated in FIG. 16. As a result, the environment setting unit 35a can transmit the environment setting information including the priority information to an information processing apparatus 200 via the communication unit 33.

For example, as illustrated in FIG. 16, in a display region WA-4 included in the environment setting window Wβ, a check box for receiving selection of a priority user who wishes to emphasize the voice in the voice overlapping section from among the participants of the online communication is provided. The priority user can be set according to, for example, a user context of a user such as a user who wants to hear a person who speaks an important matter that should not be missed in an online meeting, a person who plays an important role, or the like with priority and clarity.

In addition, in a display region WA-5 included in the environment setting window WS, a priority list for setting an exclusive priority order for emphasizing the voice is provided. The priority list includes a drop-down list. For example, when a check is inserted into a check box provided in the display region WA-4, the environment setting window Wβ illustrated in FIG. 16 receives an operation on the priority list provided in the display region WA-5, and transitions to a state in which the priority user can be selected. Each participant of the online communication can designate the priority user by operating the priority list provided in the display region WA-5 included in the environment setting window Wβ. For example, the priority list can be configured so that a list of participants of online communication such as an online meeting is displayed according to an operation on a drop-down list constituting the priority list.

In addition, numbers adjacent to the lists constituting the priority list indicate priority orders. Each participant of the online communication can individually set the priority order with respect to the other participants by operating each of the drop-down lists provided in the display region WA-5. In online communication such as an online meeting, in a case where interference (overlap) of voices occurs between users to which priority orders are assigned in the priority list, signal processing for emphasizing the voice of the user having the highest priority order is executed. For example, in the priority list, it is assumed that priority orders of “1 (rank)” to “3 (rank)” are individually assigned to users A to C who are participants of the online communication. In this case, when the voices of the users A to C interfere with each other, signal processing for emphasizing the voice of the user A whose priority order is “1 (rank)” is executed. In addition, in the environment setting window Wβ illustrated in FIG. 16, when voice interference occurs between users to which no priority order is assigned, signal processing by the emphasis method set in the display region WA-2 included in the environment setting window Wβ illustrated in FIG. 16 is executed. For example, in a case where there are a total of seven users A to G, who are participants of online communication such as an online meeting, and voice interference occurs among the four users D to G other than the users A to C given priority orders in the priority list, the signal processing by the above-described emphasis method is executed.

Furthermore, in the priority list, a uniform resource locator (URL) that notifies the schedule of the online event in advance or persons who share an e-mail may be listed. Furthermore, an icon of a new user who has newly participated in the execution of the online communication such as the online meeting may be displayed in the display region WA-3 included in the environment setting window Wβ illustrated in FIG. 16 as needed, and the information (name or the like) of the new user may be selectively displayed in the list of the participants. Each user who is a participant of the online communication can change the priority order setting at an arbitrary timing.

Note that, in a case where only one priority user is set, for example, the priority user may be designated in a drop-down list adjacent to the priority order “1”. The setting of the priority user is adopted in preference to the setting of the emphasis method in the voice signal processing of giving the effect of the binaural masking level difference.

### (4-1-2. Configuration Example of Information Processing Apparatus)

As illustrated in FIG. 15, an information processing apparatus 200 according to the second embodiment of the present disclosure has a configuration basically similar to the configuration (see FIG. 4) of the information processing apparatus 100 according to the first embodiment. Specifically, a communication unit 210, a storage unit 220, and a control unit 230 included in the information processing apparatus 200 according to the second embodiment respectively correspond to the communication unit 110, the storage unit 120, and the control unit 130 included in the information processing apparatus 100 according to the first embodiment.

Furthermore, a setting information acquiring unit 231, a signal acquiring unit 232, a signal identification unit 233, a signal processing unit 234, and a signal transmission unit 235 included in the control unit 230 of the information processing apparatus 200 according to the second embodiment respectively correspond to the setting information acquiring unit 131, the signal acquiring unit 132, the signal identification unit 133, the signal processing unit 134, and the signal transmission unit 135 included in the information processing apparatus 100 according to the first embodiment.

Then, the information processing apparatus 200 according to the second embodiment is different from the information processing apparatus 100 according to the first embodiment in that a function for implementing the voice signal processing executed on the basis of the priority user described above is provided.

Specifically, the environment setting information stored in an environment setting information storing unit 221 includes, for each of a plurality of users who can be preceding speakers or intervening speakers in online communication, priority information indicating a voice to be emphasized in a voice overlapping section. Furthermore, as illustrated in FIG. 15, the signal processing unit 234 includes a first signal inversion unit 234c and a second signal inversion unit 234d.

### (4-1-3. Specific Example of Each Unit of Information Processing System)

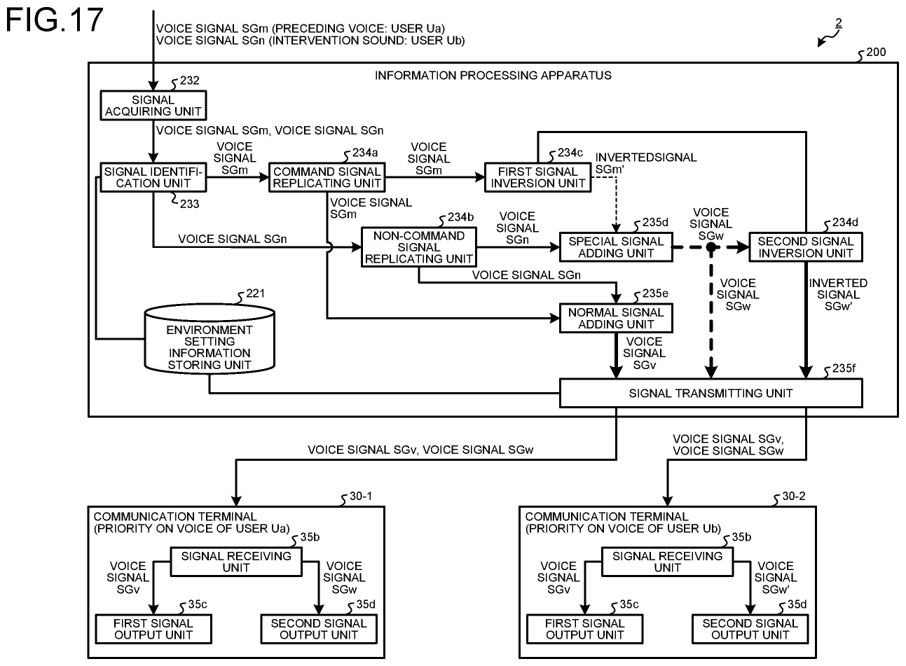

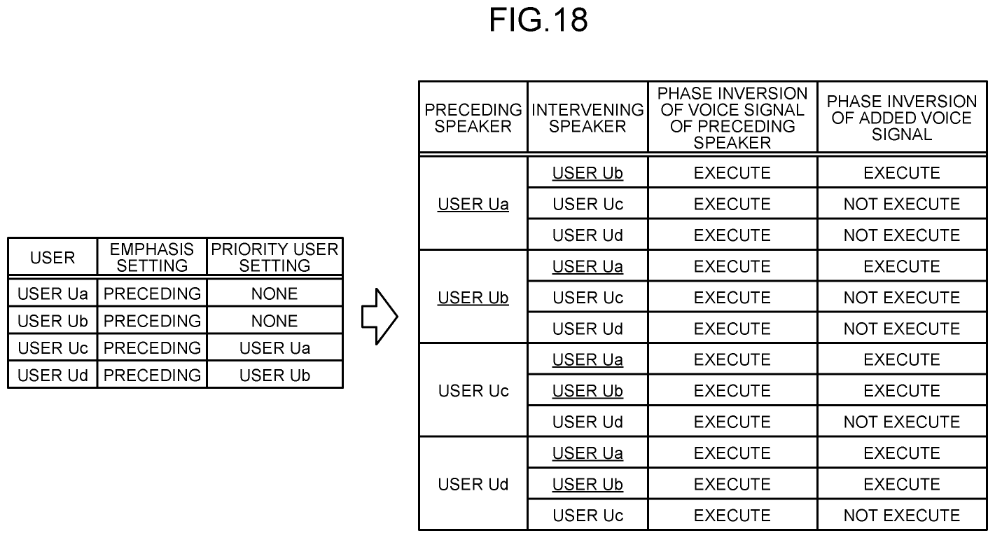

Hereinafter, a specific example of each unit of the information processing system 2 according to the second embodiment will be described with reference to FIGS. 17 and 18. FIGS. 17 and 18 are diagrams for describing a specific example of each unit of the information processing system according to the second embodiment of the present disclosure. In the following description, it is assumed that the participants of the online communication are four users Ua to Ud. In addition, in the following description, it is assumed that a functional channel set by each user is an “L channel (Lch)”, and an emphasis method selected by each user is “preceding”. Further, in the following description, it is assumed that a voice signal of the user Ua marked as a preceding speaker overlaps with a voice signal of the user Ub who is an intervening speaker. Furthermore, in the following description, it is assumed that there is no setting of the priority user for the user Ua and the user Ub, “user Ua” is set as the priority user for the user Uc, and “user Ub” is set as the priority user for the user Ud. That is, in the following description, it is assumed that a voice to be emphasized on the basis of the setting of the emphasis method and a voice to be emphasized on the basis of the setting of the priority user conflict with each other.

As illustrated in FIG. 17, the signal acquiring unit 232 acquires a voice signal SGm corresponding to the user Ua who is a preceding speaker and a voice signal SGn corresponding to the user Ub who is an intervening speaker. The signal acquiring unit 232 sends the acquired voice signal SGm and voice signal SGn to the signal identification unit 233.

After starting the online communication, for example, the signal identification unit 233 determines whether the sound pressure level of the voice signal SGm of the user Ua acquired by the signal acquiring unit 232 is equal to or higher than the threshold TH. The signal identification unit 233, when determining that the sound pressure level of the voice signal SGm is equal to or higher than the threshold TH, marks the user Ua as a preceding speaker.

Subsequently, in a case where the voice signal SGn input from the user Ub or the user Uc who is another participant in the online communication is equal to or higher than the threshold TH during the marked utterance of the user Ua, the signal identification unit 233 detects the overlap of the intervention sound. For example, in the example illustrated in FIG. 17, it is assumed that after marking the user Ua, overlapping of the voice signal of the user Ua and the voice signal of the user Ub is detected. Then, when overlapping of the intervention sound is detected, the signal identification unit 233 sends the voice signal SGm of the user Ua who is the preceding speaker to a command signal replicating unit 234a as a command voice signal and sends the voice signal SGn of the user Ub who is the intervening speaker to a non-command signal replicating unit 234b as a non-command signal while the overlapping section continues. Note that, in a case of a single voice (in a case where there is no overlap of utterance), the signal identification unit 233 sends the voice signal SGm to the non-command signal replicating unit 234b, and does not send the voice signal to the command signal replicating unit 234a. Details of the voice signal to be sent from the signal identification unit 233 to the command signal replicating unit 134a or the non-command signal replicating unit 134b are similar to those in Table 1 described above.

In addition, the command signal replicating unit 234a replicates the voice signal SGm acquired from the signal identification unit 233 as a command voice signal. Then, the command signal replicating unit 234a sends the replicated voice signal SGm to the first signal inversion unit 234c and a normal signal adding unit 235e.

In addition, the non-command signal replicating unit 234b replicates the voice signal SGn acquired from the signal identification unit 233 as a non-command voice signal. Then, the non-command signal replicating unit 234b sends the replicated voice signal SGn to a special signal adding unit 235d and the normal signal adding unit 235e.

The first signal inversion unit 234c performs phase inversion processing on the voice signal SGm acquired as the command signal from the command signal replicating unit 234a. As a result, the voice signal for which the operation for emphasizing the voice signal SGm of the user Ua has been performed is generated in the voice overlapping section. The first signal inversion unit 234c sends the inverted signal SGm′ on which the phase inversion processing has been performed to the special signal adding unit 235d.

The special signal adding unit 235d adds the voice signal SGn acquired from the non-command signal replicating unit 234b and the inverted signal SGm′ acquired from the first signal inversion unit 234c. The special signal adding unit 235d sends the added voice signal SGw to the second signal inversion unit 234d and a signal transmitting unit 235f.

The second signal inversion unit 234d performs phase inversion processing of the voice signal SGw acquired from the special signal adding unit 235d. As a result, the voice signal for which the operation for emphasizing the voice signal SGn of the user Ub has been performed is generated in the voice overlapping section. The second signal inversion unit 234d sends the inverted signal SGw′ on which the phase inversion processing has been performed to the signal transmitting unit 235f. The above-described controls of the first signal inversion unit 234c and the second signal inversion unit 234d are executed in cooperation with each other. Specifically, when the first signal inversion unit 234c does not receive a signal, the second signal inversion unit 234d also does not execute processing.

Note that, as illustrated in FIG. 18, in the environment setting information, in a case where “preceding” is selected by the users Ua to Ud as the emphasis method, “user Ua” is set as the priority user by the user Uc, and “user Ub” is set as the priority user by the user Ud, there are a plurality of patterns in which the phase inversion processing in the second signal inversion unit 234d is effective. Specifically, as illustrated in FIG. 18, when the preceding speaker is “user Ua” and the intervening speaker is “user Ub”, when the preceding speaker is “user Ub” and the intervening speaker is “user Ua”, when the preceding speaker is “user Uc” or “user Ud” and the intervening speaker is “user Ua” or “user Ub”, the phase inversion processing in the second signal inversion unit 234d is effective. Therefore, the signal processing unit 234 refers to the environment setting information, and flexibly switches whether or not to execute the phase inversion processing in the first signal inversion unit 234c and the second signal inversion unit 234d. As a result, the information processing apparatus 200 performs signal processing individually corresponding to the setting contents (emphasis method, priority user, and the like) of the participants in the online communication.

The normal signal adding unit 235e adds the voice signal SGm acquired from the command signal replicating unit 234a and the voice signal SGn acquired from the non-command signal replicating unit 234b. The normal signal adding unit 235e sends the added voice signal SGv to the signal transmitting unit 235f.

The signal transmitting unit 235f refers to the environment setting information stored in the environment setting information storing unit 221, and transmits the voice signal SGw acquired from the special signal adding unit 235d and the voice signal SGv acquired from the normal signal adding unit 235e to each of the communication terminal 30-1 and the communication terminal 30-2 through the path of the corresponding channel.

For example, the signal transmitting unit 235f assigns a path corresponding to an R channel (Rch) that is a non-functional channel to the voice signal SGv, and assigns a path corresponding to an L channel (Lch) that is a functional channel to the voice signal SGw. The signal transmitting unit 235f transmits the voice signal SGv and the voice signal SGw to the communication terminal 30-1 through each path. As a result, in the communication terminal 30-1, the voice of the user Ua who is the preceding speaker and is the priority user of the user Uc is output in a highlighted state.

Further, for example, the signal transmitting unit 235f assigns a path corresponding to an R channel (Rch) which is a non-functional channel to the voice signal SGv, and assigns a path corresponding to an L channel (Lch) which is a functional channel to the inverted signal SGw′. The signal transmitting unit 235f transmits the voice signal SGv and the voice signal SGw to the communication terminal 30-2 through each path. As a result, in the communication terminal 30-2, the voice of the user Ub who is the preceding speaker and is the priority user of the user Ud is output in a highlighted state. Note that the signal transmitting unit 235f has a selector function as described below. For example, the signal transmitting unit 235f sends the voice signal SGv generated by the normal signal adding unit 235e to the non-functional channels of all users. Furthermore, in a case where the signal transmitting unit 235f receives only the voice signal SGw corresponding to the preceding voice for the voice signal SGw generated by the special signal adding unit 235d and the inverted signal SGw′ generated by the second signal inversion unit 234d, the signal transmitting unit 235f sends the voice signal SGw to all the users. In addition, in a case where the signal transmitting unit 235f receives both the voice signal SGw and the inverted signal SGw′ for the voice signal SGw generated by the special signal adding unit 235d and the inverted signal SGw′ generated by the second signal inversion unit 234d, the signal transmitting unit 235f sends the inverted signal SGw′ instead of the voice signal SGw to the user U having the functional channel that receives the inverted signal SGw′.

In addition to the specific example described above, for example, as illustrated in FIG. 18, it is assumed that the emphasis method selected by each user is “preceding”. Furthermore, in the following description, it is assumed that there is no setting of the priority user for the user Ua and the user Ub, “user Ua” is set as the priority user for the user Uc, and “user Ub” is set as the priority user for the user Ud.

### <4-2. Processing Procedure Example>

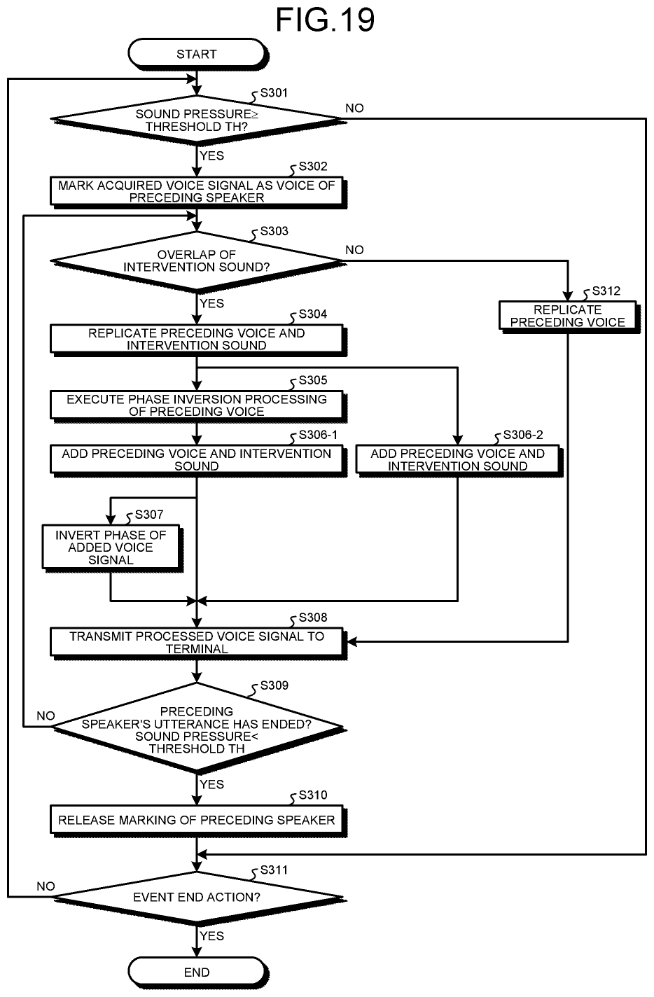

Hereinafter, a processing procedure by the information processing apparatus 200 according to the second embodiment of the present disclosure will be described with reference to FIG. 19. FIG. 19 is a flowchart illustrating an example of a processing procedure of the information processing apparatus according to the second embodiment of the present disclosure. The processing procedure illustrated in FIG. 19 is executed by the control unit 230 included in the information processing apparatus 200. Note that FIG. 19 illustrates an example of a processing procedure corresponding to the assumption described in the specific example of each unit of the information processing system 2 illustrated in FIG. 17 described above. In other words, FIG. 19 illustrates an example of a processing procedure in a case where a voice to be emphasized on the basis of the setting of the emphasis method and a voice to be emphasized on the basis of the setting of the priority user conflict with each other.

As illustrated in FIG. 19, the signal identification unit 233 determines whether the sound pressure level of the voice signal acquired from the signal acquiring unit 232 is equal to or greater than a predetermined threshold (Step S301).

Further, the signal identification unit 233, when determining that the sound pressure level of the voice signal is equal to or greater than the predetermined threshold (Step S301; Yes), marks the acquired voice signal as the voice of the preceding speaker (Hereinafter, the voice is appropriately referred to as a “preceding voice”.) (Step S302).

Furthermore, the signal identification unit 233 determines whether or not there is overlap of intervention sound (For example, the voice of the intervening speaker) input from another participant in the online communication during the marked utterance of the preceding speaker (Step S303).

When the signal identification unit 233 determines that the intervention sound overlaps (Step S303; Yes), the signal processing unit 234 replicates the preceding voice and the intervention sound (Step S304). Then, the signal processing unit 234 executes phase determination processing of the voice signal corresponding to the preceding voice (Step S305). Specifically, the command signal replicating unit 234a replicates the voice signal corresponding to the preceding voice acquired from the signal identification unit 233, and sends the replicated voice signal to the signal transmission unit 235. The non-command signal replicating unit 234b replicates the voice signal corresponding to the intervening person acquired from the signal identification unit 233, and sends the replicated voice signal to the signal transmission unit 235. In addition, the first signal inversion unit 234c sends, to the signal transmission unit 235, an inverted signal obtained by performing phase inversion processing on the voice signal corresponding to the preceding voice.

In addition, the signal transmission unit 235 adds the preceding voice acquired from the signal processing unit 234 and the intervention sound (Step S306-1, S306-2). Specifically, in the processing procedure of Step S306-1, the special signal adding unit 235d adds the inverted signal corresponding to the preceding voice acquired from the first signal inversion unit 234c and the voice signal corresponding to the intervention sound acquired from the non-command signal replicating unit 234b. The special signal adding unit 235d sends the added voice signal to the second signal inversion unit 234d and the signal transmitting unit 235f. In addition, in the processing procedure of Step S306-2, the normal signal adding unit 235e adds the voice signal corresponding to the preceding voice acquired from the command signal replicating unit 234a and the voice signal corresponding to the intervening person acquired from the non-command signal replicating unit 234b. The normal signal adding unit 235e sends the added voice signal to the signal transmitting unit 235f.

In addition, the signal processing unit 234 executes phase inversion processing of the added voice signal acquired from the special signal adding unit 235d (Step S307). Specifically, the second signal inversion unit 234d sends, to the signal transmitting unit 235f, the phase-inverted added voice signal (inverted signal) obtained by performing the phase inversion processing on the added voice signal.

In addition, the signal transmission unit 235 transmits the processed voice signal to the communication terminal 30 (Step S308).

The signal identification unit 233 also determines whether or not the preceding speaker's utterance has ended (Step S309). Specifically, for example, when the sound pressure level of the voice signal corresponding to the preceding speaker is less than a predetermined threshold, the signal identification unit 233 determines that the preceding speaker's utterance has ended.

If the signal identification unit 233 determines that the preceding speaker's utterance has not ended (Step S309; No), the processing returns to the processing procedure of Step S303 described above.

On the other hand, the signal identification unit 233, when determining that the preceding speaker's utterance has ended (Step S309; Yes), releases the marking on the preceding speaker (Step S310).

Furthermore, the control unit 230 determines whether or not an event end action has been received from the communication terminal 30 (Step S311). For example, the control unit 230 can end the processing procedure illustrated in FIG. 19 on the basis of a command from the communication terminal 30. Specifically, when receiving the end command of the online communication from the communication terminal 30 during the execution of the processing procedure illustrated in FIG. 19, the control unit 230 can determine that the event end action has been received. For example, the end command can be configured to be transmittable from the communication terminal 30 to the information processing apparatus 200 by using an operation of the user U on an “end” button displayed on the screen of the communication terminal 30 as a trigger during execution of the online communication.

The control unit 230, when determining that the event end action has not been received (Step S311; No), returns to the processing procedure of Step S301 described above.

On the other hand, the control unit 230, when determining that the event end action has been received (Step S311; Yes), ends the processing procedure illustrated in FIG. 19.

When the signal identification unit 233 determines that the intervention sound does not overlap in the processing procedure of Step S303 described above (Step S303; No), that is, when the acquired voice signal is a single voice, the signal processing unit 234 replicates only the preceding voice (Step S312), and proceeds to the processing procedure of Step S308 described above.

In the processing procedure of Step S301 described above, the signal identification unit 233, when determining that the sound pressure level of the voice signal is less than the predetermined threshold (Step S301; No), proceeds to the processing procedure of Step S311 described above.

### 5. Others

In each of the embodiments and the modifications described above, the case where the voice signal transmitted from the communication terminal 10 is a monaural signal has been described. However, also in a case where the voice signal transmitted from the communication terminal 10 is a stereo signal, the information processing implemented by the information processing apparatus 100 according to each of the embodiments and the modifications described above can be similarly applied. For example, as the voice signal for the right ear and the voice signal for the left ear, signal processing of voice signals of 2 ch each is executed. Furthermore, the information processing apparatus 100 that processes a stereo signal has a functional configuration similar to that of the information processing apparatus 100 described above except for the command signal replicating unit 134a and the non-command signal replicating unit 134b (see FIG. 4) that are necessary in a case where a monaural signal is processed. Furthermore, the internal configuration of the information processing apparatus 200 that processes a stereo signal also has a functional configuration similar to that of the information processing apparatus 200 described above except for the command signal replicating unit 234a and the non-command signal replicating unit 234b (see FIG. 15).

In addition, various programs for implementing the information processing method (See, for example, FIGS. 10, 14, and 19.) executed by the information processing apparatus (As an example, the information processing apparatus 100 or the information processing apparatus 200) according to each of the above-described embodiments and modifications may be stored and distributed in a computer-readable recording medium or the like such as an optical disk, a semiconductor memory, a magnetic tape, or a flexible disk. At this time, the information processing apparatus according to each of the embodiments and the modifications can implement the information processing method according to each of the embodiments and the modifications of the present disclosure by installing and executing various programs in a computer.

In addition, various programs for implementing the information processing method (See, for example, FIGS. 10, 14, and 19.) executed by the information processing apparatus (As an example, the information processing apparatus 100 or the information processing apparatus 200) according to each of the above-described embodiments and modifications may be stored in a disk device included in a server on a network such as the Internet and may be downloaded to a computer. In addition, functions provided by various programs for implementing the information processing method according to each of the above-described embodiments and modifications may be implemented by cooperation of the OS and the application program. In this case, a portion other than the OS may be stored in a medium and distributed, or a portion other than the OS may be stored in an application server and downloaded to a computer.

In addition, among the processing described in the above-described embodiments and modifications, all or a part of the processing described as being automatically performed can be manually performed, or all or a part of the processing described as being manually performed can be automatically performed by a known method. In addition, the processing procedure, specific name, and information including various data and parameters illustrated in the document and the drawings can be arbitrarily changed unless otherwise specified. For example, the various types of information illustrated in each figure are not limited to the illustrated information.

In addition, each component of the information processing apparatus (As an example, the information processing apparatus 100 or the information processing apparatus 200) according to each of the above-described embodiments and modifications is functionally conceptual, and is not necessarily required to be configured as illustrated in the drawings. For example, the respective units (Command signal replicating unit 134a, non-command signal replicating unit 134b, and signal inversion unit 134c) of the signal processing unit 134 included in the information processing apparatus 100 may be functionally integrated. Furthermore, the respective units (Special signal adding unit 135d, normal signal adding unit 135e, and signal transmitting unit 135f) of the signal transmission unit 135 included in the information processing apparatus 100 may be functionally integrated. The same applies to the signal processing unit 234 and the signal transmission unit 235 included in the information processing apparatus 200.

In addition, the embodiment and the modification of the present disclosure can be appropriately combined within a range not contradicting processing contents. Furthermore, the order of each step illustrated in the flowchart according to the embodiment of the present disclosure can be changed as appropriate.

Although the embodiments and modifications of the present disclosure have been described above, the technical scope of the present disclosure is not limited to the above-described embodiments and modifications, and various modifications can be made without departing from the gist of the present disclosure. In addition, components of different embodiments and modifications may be appropriately combined.

### 6. Hardware Configuration Example

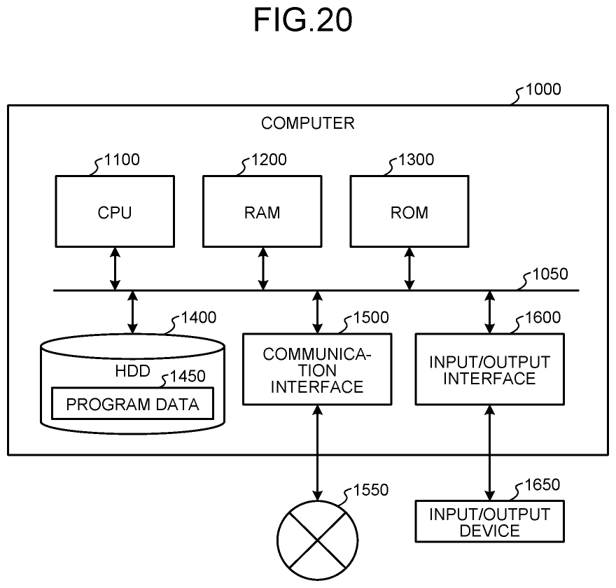

A hardware configuration example of a computer corresponding to the information processing apparatus (As an example, the information processing apparatus 100 or the information processing apparatus 200) according to each of the above-described embodiments and modifications will be described with reference to FIG. 20. FIG. 20 is a block diagram illustrating a hardware configuration example of a computer corresponding to the information processing apparatus according to each of the embodiments and modifications of the present disclosure. Note that FIG. 20 illustrates an example of a hardware configuration of a computer corresponding to the information processing apparatus according to each of the embodiments and modifications of the present disclosure, and is not necessarily limited to the configuration illustrated in FIG. 20.

As illustrated in FIG. 14, a computer 1000 corresponding to the information processing apparatus according to each of the embodiments and modifications of the present disclosure includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 records program data 1450. The program data 1450 is an example of an information processing program for implementing the information processing method according to each of the embodiments and modifications of the present disclosure, and data used by the information processing program.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display device, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus (As an example, the information processing apparatus 100 or the information processing apparatus 200) according to each of the embodiments and modifications of the present disclosure, the CPU 1100 of the computer 1000 executes the information processing program loaded on the RAM 1200 to implement various processing functions executed by each unit of the control unit 130 illustrated in FIG. 4 and various processing functions executed by each unit of the control unit 230 illustrated in FIG. 15.

That is, the CPU 1100, the RAM 1200, and the like implement information processing by the information processing apparatus (As an example, the information processing apparatus 100 or the information processing apparatus 200) according to each of the embodiments and modifications of the present disclosure in cooperation with software (information processing program loaded on the RAM 1200).

### 7. Conclusion

An information processing apparatus (As an example, the information processing apparatus 100 or the information processing apparatus 200) according to each of the embodiments and modifications of the present disclosure includes a signal acquiring unit, a signal identification unit, a signal processing unit, and a signal transmission unit. The signal acquiring unit acquires at least one of a first voice signal corresponding to the voice of the preceding speaker and a second voice signal corresponding to the voice of the intervening speaker from the communication terminal (As an example, the communication terminal 10). When the signal strengths of the first voice signal and the second voice signal exceed a predetermined threshold, the signal identification unit specifies an overlapping section in which the first voice signal and the second voice signal overlap, and identifies either the first voice signal or the second voice signal as a phase inversion target in the overlapping section. The phase inversion processing is performed on one voice signal identified as a phase inversion target by the signal identification unit and the signal identification unit while an overlapping section continues. The signal transmission unit adds one voice signal on which the phase inversion processing has been performed and the other voice signal on which the phase inversion processing has not been performed, and transmits the added voice signal to the communication terminal. As a result, the information processing apparatus according to each of the embodiments and modifications of the present disclosure can support implementation of smooth communication, for example, in online communication on the premise of normal hearing.

In addition, in each of the embodiments and modifications of the present disclosure, the signal identification unit identifies the first voice signal as the phase inversion target when emphasizing the voice of the preceding speaker, and the signal processing unit performs the phase inversion processing on the first voice signal during the overlapping section. The signal transmission unit adds the first voice signal on which the phase inversion processing has been performed and the second voice signal on which the phase inversion processing has not been performed. As a result, it is possible to support implementation of smooth communication through voice emphasis of the preceding speaker.

Further, in each of the embodiments and modifications of the present disclosure, the signal identification unit identifies the second voice signal as the phase inversion target when emphasizing the voice of the intervening speaker, and the signal processing unit performs the phase inversion processing on the second voice signal during the overlapping section. The signal transmission unit adds the first voice signal on which the phase inversion processing has not been performed and the second voice signal on which the phase inversion processing has been performed. As a result, it is possible to support implementation of smooth communication through voice emphasis of the intervening speaker.

Furthermore, in each of the embodiments and the modifications of the present disclosure, the first voice signal and the second voice signal are monaural signals or stereo signals. As a result, it is possible to support implementation of smooth communication regardless of the type of the voice signal.

Furthermore, in each of the embodiments and the modifications of the present disclosure, in a case where the first voice signal and the second voice signal are monaural signals, a signal replicating unit that replicates each of the first voice signal and the second voice signal is further provided. As a result, for example, processing corresponding to a 2-ch audio output device such as headphones or an earphone can be implemented.

In addition, in each of the embodiments and the modifications of the present disclosure, a storage unit that stores priority information indicating a voice to be emphasized in the overlapping section for each of a plurality of users who can be preceding speakers or intervening speakers is further provided. The signal processing unit executes phase inversion processing of the first voice signal or the second voice signal on the basis of the priority information. As a result, it is possible to implement support of smooth communication through voice emphasis of the user prioritized by each participant of the online communication.

Furthermore, in each of the embodiments and the modifications of the present disclosure, the priority information is set on the basis of the context of the user. As a result, it is possible to implement support of smooth communication through prevention of missing of an important voice.

Furthermore, in each of the embodiments and the modifications of the present disclosure, the signal processing unit executes signal processing to which a binaural masking level difference is applied by phase inversion processing. As a result, it is possible to implement support of smooth communication while suppressing the load of signal processing.

Furthermore, the effects described in the present specification are merely illustrative or exemplary, and are not restrictive. That is, the technology according to the present disclosure can exhibit other effects obvious to those skilled in the art from the description of the present specification together with or instead of the above effects.

Note that the technology of the present disclosure can also have the following configurations as belonging to the technical scope of the present disclosure.

(1)

An information processing apparatus comprising:
a signal acquiring unit that acquires at least one of a first voice signal corresponding to a voice of a preceding speaker and a second voice signal corresponding to a voice of an intervening speaker from a communication terminal;
a signal identification unit that specifies an overlapping section in which the first voice signal and the second voice signal overlap with each other and identifies either the first voice signal or the second voice signal as a phase inversion target in the overlapping section when signal strengths of the first voice signal and the second voice signal exceed a predetermined threshold;
a signal processing unit that performs phase inversion processing on one voice signal identified as the phase inversion target by the signal identification unit while the overlapping section continues; and a signal transmission unit that adds one voice signal on which the phase inversion processing has been performed and the other voice signal on which the phase inversion processing has not been performed, and transmits the added voice signal to the communication terminal.
   (2)

The information processing apparatus according to (1), wherein
the signal identification unit
identifies the first voice signal as the phase inversion target when emphasizing the voice of the preceding speaker,
the signal processing unit
performs the phase inversion processing on the first voice signal during the overlapping section, and
the signal transmission unit
adds the first voice signal on which the phase inversion processing has been performed and the second voice signal on which the phase inversion processing has not been performed.
   (3)

The information processing apparatus according to (1), wherein
the signal identification unit
identifies the second voice signal as the phase inversion target when emphasizing the voice of the intervening speaker,
the signal processing unit
performs the phase inversion processing on the second voice signal during the overlapping section, and
the signal transmission unit
adds the first voice signal on which the phase inversion processing has not been performed and the second voice signal on which the phase inversion processing has been performed.
   (4)

The information processing apparatus according to any one of (1) and (3), wherein
the first voice signal and the second voice signal are monaural signals or stereo signals.
   (5)

The information processing apparatus according to any one of (1) and (4), further comprising
a signal replicating unit that replicates the first voice signal and the second voice signal when the first voice signal and the second voice signal are monaural signals.
   (6)

The information processing apparatus according to any one of (1) and (5), further comprising
a storage unit that stores priority information for each of a plurality of users who can be the preceding speaker or the intervening speaker, wherein
the signal processing unit
executes phase inversion processing of the first voice signal or the second voice signal on a basis of the priority information.
   (7)

The information processing apparatus according to (6), wherein
the priority information is set on a basis of a context of the user.
   (8)

The information processing apparatus according to any one of (1) and (7), wherein
the signal processing unit
executes signal processing using a binaural masking level difference generated in a case where a voice signal processed by the phase inversion processing and a voice signal not processed by the phase inversion processing are simultaneously heard from different ears, respectively.
   (9)

The information processing apparatus according to any one of (1) and (8), further comprising
a setting information acquiring unit that acquires, for each user, environment setting information including information on a function channel selected by the user and information on an emphasis method.
   (10)

The information processing apparatus according to (9), further comprising
an environment setting information storing unit that stores the environment setting information acquired by the setting information acquiring unit.
   (11)

The information processing apparatus according to (9), wherein
the setting information acquiring unit acquires the environment setting information through an environment setting window provided to the user.
   (12)

An information processing method comprising:
acquiring, by a computer, at least one of a first voice signal corresponding to a voice of a preceding speaker and a second voice signal corresponding to a voice of an intervening speaker from a communication terminal;
specifying, by the computer, an overlapping section in which the first voice signal and the second voice signal overlap with each other and identifying either the first voice signal or the second voice signal as a phase inversion target in the overlapping section when signal strengths of the first voice signal and the second voice signal exceed a predetermined threshold;
performing, by the computer, phase inversion processing on one voice signal identified as the phase inversion target while the overlapping section continues; and
adding, by the computer, one voice signal on which the phase inversion processing has been performed and the other voice signal on which the phase inversion processing has not been performed, and transmitting the added voice signal to the communication terminal.
   (13)

An information processing program causing a computer to function as a control unit that:
acquires at least one of a first voice signal corresponding to a voice of a preceding speaker and a second voice signal corresponding to a voice of an intervening speaker from a communication terminal;
specifies an overlapping section in which the first voice signal and the second voice signal overlap with each other and identifies either the first voice signal or the second voice signal as a phase inversion target in the overlapping section when signal strengths of the first voice signal and the second voice signal exceed a predetermined threshold;
performs phase inversion processing on one voice signal identified as the phase inversion target while the overlapping section continues; and
adds one voice signal on which the phase inversion processing has been performed and the other voice signal on which the phase inversion processing has not been performed, and transmits the added voice signal to the communication terminal.
   (14)

An information processing system comprising:
a plurality of communication terminals; and
an information processing apparatus, wherein
the information processing apparatus includes:
a signal acquiring unit that acquires at least one of a first voice signal corresponding to a voice of a preceding speaker and a second voice signal corresponding to a voice of an intervening speaker from the communication terminals;
a signal identification unit that specifies an overlapping section in which the first voice signal and the second voice signal overlap with each other and identifies either the first voice signal or the second voice signal as a phase inversion target in the overlapping section when signal strengths of the first voice signal and the second voice signal exceed a predetermined threshold;
a signal processing unit that performs phase inversion processing on one voice signal identified as the phase inversion target by the signal identification unit while the overlapping section continues; and
a signal transmission unit that adds one voice signal on which the phase inversion processing has been performed and the other voice signal on which the phase inversion processing has not been performed, and transmits the added voice signal to the communication terminals.

### REFERENCE SIGNS LIST

1, 2 INFORMATION PROCESSING SYSTEM
10, 30 COMMUNICATION TERMINAL
11, 31 INPUT UNIT
12, 32 OUTPUT UNIT
13, 33 COMMUNICATION UNIT
14, 34 STORAGE UNIT
15, 35 CONTROL UNIT
20 HEADPHONES
100, 200 INFORMATION PROCESSING APPARATUS
110, 210 COMMUNICATION UNIT
120, 220 STORAGE UNIT
121, 221 ENVIRONMENT SETTING INFORMATION STORING UNIT
130, 230 CONTROL UNIT
131, 231 SETTING INFORMATION ACQUIRING UNIT
132, 232 SIGNAL ACQUIRING UNIT
133, 233 SIGNAL IDENTIFICATION UNIT
134, 234 SIGNAL PROCESSING UNIT
134a, 234a COMMAND SIGNAL REPLICATING UNIT
134b, 234b NON-COMMAND SIGNAL REPLICATING UNIT
134c SIGNAL INVERSION UNIT
135, 235 SIGNAL TRANSMISSION UNIT
135d, 235d SPECIAL SIGNAL ADDING UNIT
135e, 235e NORMAL SIGNAL ADDING UNIT
135f, 235f SIGNAL TRANSMITTING UNIT
234c FIRST SIGNAL INVERSION UNIT
234d SECOND SIGNAL INVERSION UNIT

1. An information processing apparatus comprising:
a signal acquiring unit that acquires at least one of a first voice signal corresponding to a voice of a preceding speaker and a second voice signal corresponding to a voice of an intervening speaker from a communication terminal;
a signal identification unit that specifies an overlapping section in which the first voice signal and the second voice signal overlap with each other and identifies either the first voice signal or the second voice signal as a phase inversion target in the overlapping section when signal strengths of the first voice signal and the second voice signal exceed a predetermined threshold;
a signal processing unit that performs phase inversion processing on one voice signal identified as the phase inversion target by the signal identification unit while the overlapping section continues; and
a signal transmission unit that adds one voice signal on which the phase inversion processing has been performed and the other voice signal on which the phase inversion processing has not been performed, and transmits the added voice signal to the communication terminal.

2. The information processing apparatus according to claim 1, wherein
the signal identification unit
identifies the first voice signal as the phase inversion target when emphasizing the voice of the preceding speaker,
the signal processing unit
performs the phase inversion processing on the first voice signal during the overlapping section, and
the signal transmission unit
adds the first voice signal on which the phase inversion processing has been performed and the second voice signal on which the phase inversion processing has not been performed.

3. The information processing apparatus according to claim 1, wherein
the signal identification unit
identifies the second voice signal as the phase inversion target when emphasizing the voice of the intervening speaker,
the signal processing unit
performs the phase inversion processing on the second voice signal during the overlapping section, and
the signal transmission unit
adds the first voice signal on which the phase inversion processing has not been performed and the second voice signal on which the phase inversion processing has been performed.

4. The information processing apparatus according to claim 1, wherein
the first voice signal and the second voice signal are monaural signals or stereo signals.

5. The information processing apparatus according to claim 1, further comprising
a signal replicating unit that replicates the first voice signal and the second voice signal when the first voice signal and the second voice signal are monaural signals.

6. The information processing apparatus according to claim 1, further comprising
a storage unit that stores priority information for each of a plurality of users who can be the preceding speaker or the intervening speaker, wherein
the signal processing unit
executes phase inversion processing of the first voice signal or the second voice signal on a basis of the priority information.

7. The information processing apparatus according to claim 6, wherein
the priority information is set on a basis of a context of the user.

8. The information processing apparatus according to claim 1, wherein
the signal processing unit executes signal processing using a binaural masking level difference generated in a case where a voice signal processed by the phase inversion processing and a voice signal not processed by the phase inversion processing are simultaneously heard from different ears, respectively.

9. The information processing apparatus according to claim 1, further comprising
a setting information acquiring unit that acquires, for each user, environment setting information including information on a function channel selected by the user and information on an emphasis method.

10. The information processing apparatus according to claim 9, further comprising
an environment setting information storing unit that stores the environment setting information acquired by the setting information acquiring unit.

11. The information processing apparatus according to claim 9, wherein
the setting information acquiring unit acquires the environment setting information through an environment setting window provided to the user.

12. An information processing method comprising:
acquiring, by a computer, at least one of a first voice signal corresponding to a voice of a preceding speaker and a second voice signal corresponding to a voice of an intervening speaker from a communication terminal;
specifying, by the computer, an overlapping section in which the first voice signal and the second voice signal overlap with each other and identifying either the first voice signal or the second voice signal as a phase inversion target in the overlapping section when signal strengths of the first voice signal and the second voice signal exceed a predetermined threshold;
performing, by the computer, phase inversion processing on one voice signal identified as the phase inversion target while the overlapping section continues; and
adding, by the computer, one voice signal on which the phase inversion processing has been performed and the other voice signal on which the phase inversion processing has not been performed, and transmitting the added voice signal to the communication terminal.

13. An information processing program causing a computer to function as a control unit that:
acquires at least one of a first voice signal corresponding to a voice of a preceding speaker and a second voice signal corresponding to a voice of an intervening speaker from a communication terminal;
specifies an overlapping section in which the first voice signal and the second voice signal overlap with each other and identifies either the first voice signal or the second voice signal as a phase inversion target in the overlapping section when signal strengths of the first voice signal and the second voice signal exceed a predetermined threshold;
performs phase inversion processing on one voice signal identified as the phase inversion target while the overlapping section continues; and
adds one voice signal on which the phase inversion processing has been performed and the other voice signal on which the phase inversion processing has not been performed, and transmits the added voice signal to the communication terminal.

14. An information processing system comprising:
a plurality of communication terminals; and
an information processing apparatus, wherein
the information processing apparatus includes:
a signal acquiring unit that acquires at least one of a first voice signal corresponding to a voice of a preceding speaker and a second voice signal corresponding to a voice of an intervening speaker from the communication terminals;
a signal identification unit that specifies an overlapping section in which the first voice signal and the second voice signal overlap with each other and identifies either the first voice signal or the second voice signal as a phase inversion target in the overlapping section when signal strengths of the first voice signal and the second voice signal exceed a predetermined threshold;
a signal processing unit that performs phase inversion processing on one voice signal identified as the phase inversion target by the signal identification unit while the overlapping section continues; and
a signal transmission unit that adds one voice signal on which the phase inversion processing has been performed and the other voice signal on which the phase inversion processing has not been performed, and transmits the added voice signal to the communication terminals.
